(19) United States
(12) Patent Application Publication
(10) Pub. No.: US 2022/0306792 A1
(43) Pub. Date: Sep. 29, 2022

(54) GRAFT COPOLYMERS FOR COMPATIBILIZATION OF POLYETHYLENE AND POLYPROPYLENE

(71) Applicant: CORNELL UNIVERSITY, lthaca, NY (US)

(72) Inventors: Geoffrey W. Coates, Lansing, NY (US); Anne M. Lapointe, Ithaca, NY (US); Kristine Klimovica, St. Paul, MN (US); Ting-Wei Lin, Ithaca, NY (US); James M. Eagan, Fairlawn, OH (US)

(21) Appl. No.: 17/642,461

(22) PCT Filed: Sep. 14, 2020
(86) PCT No.: PCT/US2020/050770

§ 371 Date: Mar. 11, 2022

Related U.S. Application Data
(60) Provisional application No. 62/900,097, filed on Sep. 13, 2019.

(51) Int. Cl. C08F 255/02; C08L 51/00

(52) U.S. Cl. CPC C08F 255/02; C08L 51/003

(57) ABSTRACT

Provided are graft copolymers, methods of making graft copolymers, polymer blends made from graft copolymers, methods of making polymer blends, and articles made from graft copolymers and blends thereof. The graft copolymers may be made from ethylene and isotactic polypropylene. The polymer blends may be made from semi-crystalline polyethylene, polypropylene, and a graft copolymer of the present disclosure.

### CROSS REFERENCE TO RELATED APPLICATIONS

This application claims priority to U.S. Provisional Application No. 62/900,097, filed on Sep. 13, 2019, the disclosure of which is incorporated herein by reference.

### STATEMENT REGARDING FEDERALLY SPONSORED RESEARCH

This invention was made with government support under contract no. 1413862 and 1901635 awarded by the National Science Foundation. The government has certain rights in the invention.

### BACKGROUND OF THE DISCLOSURE

Plastics are an integral part of modern society, and the production of industrial polymers has increased dramatically since 1970. Unfortunately, most plastics are disposed of in landfills or the environment. This is a concern for polyethylene (PE) and isotactic polypropylene (iPP), which account for ⅔ of all polymers produced worldwide and are commonly employed in single-use applications such as packaging. Currently, approximately 1% of iPP and less than 7% of PE are recycled. The low recycling rate is largely due to the recycling challenges presented by mixed polyolefin waste streams. High-density polyethylene (HDPE) and iPP are commonly found together in commingled plastic waste and are difficult to separate using optical or density sorting technologies. Melt reprocessing HDPE and iPP waste into a blend product is one potentially useful way to circumvent the need for separation of the waste streams. However, blends of HDPE and iPP are often brittle and have poor mechanical properties due to phase separation of the two polymers.

The majority of HDPE and iPP produced industrially are made using heterogeneous catalysts. Previous studies showed that HDPE and iPP prepared with heterogeneous catalysts contain significant amounts of non-crystallizable, amorphous material, which rapidly migrates to the interface and inhibits entanglements, co-crystallization and adhesion. Therefore, the ability to overcome the interfacial activity of amorphous chains is very important. The addition of nonreactive compatibilizers to HDPE and iPP blends is one way to improve their mechanical properties and represents a potential pathway for utilization of mixed waste recycling streams. Current strategies for non-reactive compatibilization of HDPE and iPP rely on using relatively large amounts (≥10 wt %) of amorphous copolymer additives. While portions of these copolymers are usually miscible with HDPE and iPP giving rise to some compatibilization activity, the use of such large additive quantities results in plasticization that deteriorates the physical properties of the blend. Block copolymers have found application in compatibilization of other types of polymers, and offer an attractive route for compatibilization of HDPE and iPP.

It was reported that the use of olefin block copolymers (OBC) as compatibilizers and adhesives. The tensile properties of iPP-HDPE blends were improved with the addition of 10 wt % of a PE-poly(ethylene-co-octene) (PE-EO) OBC, which was attributed to enhanced adhesion between HDPE and iPP domains. PE-iPP diblock copolymers (sold commercially as INTUNE™) were also tested as compatibilizers and tie layers for PE and iPP. As was the case with the PE-EO OBCs, compatibilization of the iPPHDPE blends was observed at relatively high loading levels (5-10 wt %). However, due to the nature of the chain shuttling chemistry used to produce the OBCs, they are comprised of various block lengths and different numbers of blocks per chain.

It was reported that the addition of linear PE-b-iPP multiblock copolymers to PE and iPP blends significantly improved the tensile properties at low additive loadings (FIG. 1a). The well-defined nature of the multiblock additive as well as the controlled manner of synthesis allowed a systematic study of the effects of the number and sizes of the blocks on the efficacy of compatibilization.

Previous studies on polyolefin-based thermoplastic elastomers showed that the physical properties of well-defined graft copolymers featuring semi-crystalline side-chains and amorphous backbones rivaled or exceeded those of linear block copolymers, and could be prepared using non-living polymerizations. The graft copolymer elastomers were prepared using a “grafting through” strategy by copolymerizing allyl-terminated iso- or syndiotactic polypropylene macromonomers with mixtures of ethylene and octene or propylene.

Graft copolymers (GCPs) containing a semicrystalline PE backbone and iPP side chains (PE-g-iPP) were previously prepared via a “grafting to” method by the reaction of hydroxyl-terminated iPP with maleated PE. However, the presence of substantial amounts of difunctionalized iPP led to the formation of mixtures of polymer architectures. Others have reported that comb-block copolymers containing a PE main chain and atactic polypropylene grafts can compatibilize HDPE and iPP. However, these materials were prepared in serial reactors and the graft architecture was not fully characterized.

### SUMMARY OF THE DISCLOSURE

The present disclosure provides polymers (e.g., copolymers, such as, for example, graft copolymers). Also provided are blends of the polymers (e.g., polymer blends). Also provided are methods of making the polymers and making the polymer blends.

In an aspect, the present disclosure provides polymers. The polymers may be graft copolymers. The graft copolymers may be graft copolymers of polyethylene (PE) and isotactic polypropylene (iPP).

In an aspect, the present disclosure provides polymer blends (e.g., graft copolymer blends). The polymer blends may be a blend of a graft copolymer of the present disclosure and one or more semi-crystalline polyethylene(s), a graft copolymer of the present disclosure and one or more iPP(s), or a graft copolymer of the present disclosure and one or more semi-crystalline polyethylene(s) and one or more iPP(s).

In an aspect, a graft copolymer is prepared by a method of the present disclosure. A method may comprise polymerization of iPP and ethylene.

In an aspect, the present disclosure provides a method of making a polymer blend (e.g., a graft copolymer blend). A graft copolymer blend may be prepared by melt-blending a graft copolymer of the present disclosure with semi-crystalline polyethylene or a graft copolymer of the present disclosure with iPP or a graft copolymer of the present disclosure with iPP and semi-crystalline polyethylene.

In an aspect, the present disclosure provides articles of manufacture. The articles of manufacture (e.g., articles) comprise a graft copolymer of the present disclosure or a polymer blend (e.g., graft copolymer blend) of the present disclosure.

### BRIEF DESCRIPTION OF THE FIGURES

For a fuller understanding of the nature and objects of the disclosure, reference should be made to the following detailed description taken in conjunction with the accompanying figures.

FIG. 1 shows additives for compatibilization of iPP/HDPE blends. (a) well-defined PE-b-iPP multiblock copolymers and (b) PE-g-iPP graft copolymers (c) PE-g-iPP graft copolymer architectural variations.

FIG. 2 shows TEM images and iPP average droplet size of iPP/HDPE 30/70 blends with (a) no compatibilizer and (b) 5 wt % ³⁹⁸PE₁₅-g-_{9.3}iPP₂₆ compatibilizer. (c) Effect of number of grafts/chain on droplet size for 5 wt % (orange; 10° C./min cooling rate) and 1 wt % (at 10° C./min and 23° C./min cooling rates) ³⁹⁸PE₁₅-g-_{9.3}iPP₂₆ compatibilizer. The error bars are 95% confidence intervals.

FIG. 3 shows (a) representative uniaxial tensile elongation experiments of pure HDPE and iPP and blends of 30/70 iPP/HDPE with PE-g-iPP copolymers of varied graft size (5 wt % of GCP cooled at 10° C./min). (b)(c) Representative AFM images of stretched tensile test samples blended with GCPs of varied graft size, ellipses are added for visualization of elongated droplets. See FIG. 15 for raw data.

FIG. 4 shows average strain at break for blends of 30/70 iPP/HDPE containing 5 wt % PE-g-iPP copolymers cooled at 10° C./minute. A minimum of five tensile measurements were performed for each blend. Graft copolymers containing 26k and 28k grafts are shown in the same series. See Table 1 for standard deviation.

FIG. 5 shows representative uniaxial tensile elongation experiments of pure HDPE and iPP and blends of 30/70 iPP/HDPE with PE-g-iPP copolymers of varied graft size with 1 wt % of GCP (a) cooled at 10° C./min and (b) cooled at 23° C./min.

FIG. 6 shows a general synthetic scheme for the synthesis of PE-g-iPP copolymers.

FIG. 7 shows (A) area vs GPC sample mass plot for 6K-iPP macromonomer (Table 2, Entry 2). (B) Area vs GPC sample mass plot for 14k-iPP macromonomer (Table 2, Entry 3). (C) Area vs GPC sample mass plot for 14k-iPP macromonomer (Table 2, Entry 4). (D) Area vs GPC sample mass plot for 26k-iPP macromonomer (Table 2, Entry 5). (E) Area vs GPC sample mass plot for 28k-iPP macromonomer (Table 2, Entry 6).

FIG. 8 shows experimental GPC trace and fitted GPC curves for graft copolymer mixtures (A) ¹⁸⁵PE_{5.2}-g-₁₆iPP₆, (B) ²²¹PE₁₅-g-₁₀iPP₆ (C) ⁶³PE_{5.5}-g-_{5.0}iPP₆ (D) ¹⁶⁴PE₁₃-g-_{5.5}iPP₁₄, (E) ²¹⁰PE_{8.9}-g-_{8.8}iPP₁₄, (F) ²⁶⁰PE_{8.8}-g-₁₁iPP₁₄, (G) ²¹²PE₅₇-g-_{2.2}iPP₁₄, (H) ³⁶⁴PE₇₄-g-_{2.9}iPP₂₆, (I) ²⁹⁸PE₃₀-g-_{4.6}iPP₂₈, (J) ³⁹⁸PE₁₅-g-_{9.3}iPP₂₆, (K) ⁴¹³PE₃₉-g-_{5.6}iPP₂₈, (L) ³²⁰PE_{9.8}-g-_{8.2}iPP₂₈.

FIG. 9 shows DSC curves of (A) the first cooling cycle and (B) the second heating cycle of graft copolymers at a heating/cooling rate of 10 K/min.

FIG. 10 shows Representative TEM micrographs and corresponding droplet size distribution for (a,b) iPP/HDPE 30/70 original blends without compatibilizers and iPP HDPE 30/70 blends with 5 wt % of (c,d) ¹⁸⁵PE_{5.2}-g-₁₆iPP₆, (e,f) ²⁶⁰PE_{8.8}-g-₁₁iPP₁₄, or (g h) ³⁹⁸PE₁₅-g-_{9.3}iPP₂₆.

FIG. 11 shows Representative TEM micrographs and corresponding droplet size distribution for iPP/HDPE 30/70 blends with 5 wt % of (a,b) ²¹³PE₅₇-g-_{2.2}iPP₁₄, (c,d) ¹⁶⁴PE₁₃-g-_{5.5}iPP₁₄, (e,f) ²¹⁰PE_{8.9}-g-_{8.8}iPP₁₄, or (g,h) ²⁶⁰PE_{8.8}-g-₁₁iPP₁₄. All samples were cooled at 10° C./min.

FIG. 12 shows representative AFM images and corresponding droplet size distribution for iPP/HDPE 30/70 blends with 1 wt % of ³⁹⁸PE₁₅-g-_{0.3}iPP₂₆ (a,b) cooled at 23° C./min (fast cool), or (c,d) cooled at 10° C./min (slow cool).

FIG. 13 shows effect of the average number of grafts/chain on droplet size for iPP/HDPE 30/70 blends with 5 wt % GCP cooled at 10° C./min. The error bars are 95% confidence intervals.

FIG. 14 shows uniaxial elongation of 30/70 iPP/HDPE blends with (A) 5 wt % ¹⁸⁵PE_{5.2}-g-₁₆iPP₆, (B) 5 wt % ²²¹PE₁₅-g-₁₀iPP₆, (C) 5 wt % ¹⁶⁴PE₁₃g-_{5.5}iPP₁₄, (D) 5 wt % ²¹⁰PE_{8.9}-g-_{8.8}iPP₁₄, (E) 5 wt % ²⁶⁰PE_{8.8}-g-₁₁iPP₁₄, (F) 5 wt % ²¹³PE₅₇-g-_{2.2}iPP₁₄, (G) 5 wt % ³⁶⁴PE₇₄-g-_{2.9}iPP₂₆, (H) 5 wt % ²⁹⁸PE₃₀-g-_{4.6}iPP₂₈, (I) 5 wt % ³⁹⁸PE₁₅-g-_{9.3}iPP₂₆, (J) 5 wt % ⁴¹³PE₃₉-g-_{5.6}iPP₂₈, (J1) 5 wt % ⁴¹³PE₃₉-g-_{5.6}iPP₂₈ cooled at 23° C./min rate, (K) 5 wt % ³²⁰PE_{9.8}-g-_{8.2}iPP₂₈, (L) 1 wt % ¹⁸⁵PE_{5.2}-g-₁₆iPP₆, (M) 0.5 wt % ¹⁸⁵PE_{5.2}-g-₁₆iPP₆, (N) 1 wt % ¹⁸⁵PE_{5.2}-g-₁₆iPP₆ cooled at 23° C./min rate, (O) 0.5 wt % ¹⁸⁵PE_{5.2}-g-₁₆iPP₆ cooled at 23° C./min rate, (P) 1 wt % ²⁶⁰PE_{8.8}-g-₁₁iPP₄, (Q) 0.5 wt % ²⁶⁰PE_{8.8}-g-₁₁iPP₁₄, (R) 1 wt % ²⁶⁰PE_{8.8}-g-₁₁iPP₁₄ cooled at 23° C./min rate, (S) 0.5 wt % ²⁶⁰PE_{8.8}-g-₁₁iPP₁₄ cooled at 23° C./min rate, (T) 1 wt % ³⁹⁸PE₁₅-g-_{0.3}iPP₂₆, (U) 0.5 wt % ³⁹⁸PE₁₅-g-_{0.3}iPP₂₆, (V) 1 wt % ³⁹⁸PE₁₅-g-_{0.3}iPP₂₆ cooled at 23° C./min rate, (X) 0.5 wt % ³⁹⁸PE₁₅-g-_{0.3}iPP₂₆ cooled at 23° C./min rate, (Y) 5 wt % 6k iPP macromonomer. Uniaxial elongation of (Z) 30/70 iPP/HDPE, (A1) HDPE, (B1) iPP, (C1) HDPE cooled at 23° C./min rate, (D1) iPP cooled at 23° C./min rate, (E1) 30/70 iPP/HDPE cooled at 23° C./min rate.

FIG. 15 shows AFM images of stretched tensile test samples consisting of 30/70 iPP/HDPE with 5 wt % GCPs. (a)(c) raw images, (b)(d) the same images as FIG. 3(b)(c), with ellipses added for visualization of elongated droplets.

### DETAILED DESCRIPTION OF THE DISCLOSURE

Although claimed subject matter will be described in terms of certain examples, other examples, including examples that do not provide all of the benefits and features set forth herein, are also within the scope of this disclosure. Various structural, logical, and process step changes may be made without departing from the scope of the disclosure.

Ranges of values are disclosed herein. The ranges set out a lower limit value and an upper limit value. Unless otherwise stated, the ranges include the lower limit value, the upper limit value, and all values between the lower limit value and the upper limit value, including, but not limited to, all values to the magnitude of the smallest value (either the lower limit value or the upper limit value) of a range.

As used herein, unless otherwise stated, the term “group” refers to a chemical entity that is monovalent (i.e., has one terminus that can be covalently bonded to other chemical species), divalent, or polyvalent (i.e., has two or more termini that can be covalently bonded to other chemical species). The term “group” also includes radicals (e.g., monovalent and multivalent, such as, for example, divalent radicals, trivalent radicals, and the like). Illustrative examples of groups include:

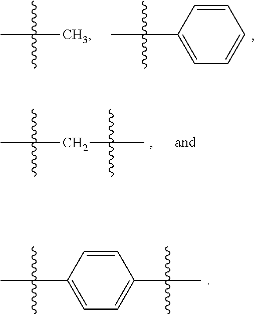

As used herein, unless otherwise indicated, the term “aliphatic groups” refers to branched or unbranched hydrocarbon groups that, optionally, contain one or more degrees of unsaturation. Degrees of unsaturation include, but are not limited to, alkenyl groups, alkynyl groups, and aliphatic cyclic groups. Aliphatic groups may be a C₁ to C₂₀ aliphatic group, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). Aliphatic groups may be unsubstituted or substituted with one or more substituents. Examples of substituents include, but are not limited to, halogens (—F, —Cl, —Br, and —I), aliphatic groups (e.g., alkyl groups, alkenyl groups, alkynyl groups, and the like), halogenated aliphatic groups (e.g., trifluoromethyl group and the like), aryl groups, halogenated aryl groups, alkoxide groups, amine groups, nitro groups, carboxylate groups, carboxylic acids, ether groups, alcohol groups, alkyne groups (e.g., acetylenyl groups and the like), and the like, and combinations thereof. Aliphatic groups may be alkyl groups, alkenyl groups, alkynyl groups, or carbocyclic groups, and the like.

As used herein, unless otherwise indicated, the term “alkyl group” refers to branched or unbranched saturated hydrocarbon groups. Examples of alkyl groups include, but are not limited to, methyl groups, ethyl groups, propyl groups, butyl groups, isopropyl groups, tert-butyl groups, and the like. For example, the alkyl group is C₁ to C₂₀, including all integer numbers of carbons and ranges of numbers of carbons therebetween (e.g., C₁, C₂, C₃, C₄, C₅, C₆, C₇, C₈, C₉, C₁₀, C₁₁, C₁₂, C₁₃, C₁₄, C₁₅, C₁₆, C₁₇, C₁₈, C₁₉, and C₂₀). The alkyl group may be unsubstituted or substituted with one or more substituents. Examples of substituents include, but are not limited to, various substituents such as, for example, halogens (—F, —Cl, —Br, and —I), aliphatic groups (e.g., alkyl groups, alkenyl groups, alkynyl groups, and the like), aryl groups, alkoxide groups, carboxylate groups, carboxylic acids, ether groups, amine groups, and the like, and combinations thereof.

The present disclosure provides polymers (e.g., copolymers, such as, for example, graft copolymers). Also provided are blends of the polymers (e.g., polymer blends).

Also provided are methods of making the polymers and making the polymer blends.

In an aspect, the present disclosure provides polymers. The polymers may be graft copolymers. The graft copolymers may be graft copolymers of polyethylene (PE) and isotactic polypropylene (iPP).

A graft copolymer may comprise a semi-crystalline polyethylene (PE) segment and a plurality of semi-crystalline isotactic polypropylene (iPP) segments. Each iPP segment is covalently bonded to the PE segment. The iPP segments are pendent groups. The graft copolymer may be described by the following equation:

^{w}PEₓ-g-_{y}iPP_{z},

where w is the overall molecular weight (in kDa), x is the average graft spacing (in kDa), z is the graft size (in kDa), and y is the average graft number.

A graft copolymer may have various molecular weights. A graft copolymer may have a number average molecular weight of 25-1000 kDa, including all 0.1 Da values and ranges therebetween (e.g., 50-500 kDa).

The PE segment of the graft copolymer may have various sizes (e.g., length (e.g., number of repeat units) and weight). The portion of the PE segment between each iPP segment may have a number average molecular weight (Mₙ) of 1-100 kDa, including all 0.1 Da values and ranges therebetween. Each portion of the PE segment may be the same length (e.g., number of repeat units) and weight or may have different lengths (e.g., number of repeat units) and weights. For example, one or more portion(s) of the PE segment have the same length and weight and one or more portion(s) of the PE segment have different lengths and weights. In various examples, the PE segment refers to the alkyl backbone formed from the copolymerization of an iPP macromonomer and PE. For example, the PE segment has the following structure:

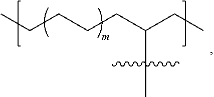

where m is 36 to 3600, including all integer values and ranges therebetween.

A graft copolymer may a various number of iPP segments. A graft copolymer may have an average of 1-50 iPP segments, including all 0.1 values and ranges therebetween. Each iPP segment may have the same or different number average molecular weight (Mₙ). An iPP segment may have an Mₙ of 1-50 kDa, including all 0.1 Da values and ranges therebetween. For example, one or more iPP segment(s) have the same length and weight and one or more iPP segment(s) have different lengths and weights. In various examples, the iPP segments may have stereochemical or regioisomeric errors.

A graft copolymer may have the following structure:

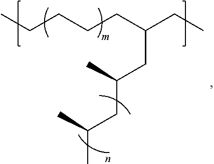

where m is 36 to 3600, including all integer values and ranges therebetween, and n is 24 to 1200, including all integer values and ranges therebetween.

In various examples, the graft copolymer may comprise a semi-crystalline iPP segment and a plurality of PE segments. Each PE segment is covalently bonded to the iPP segment. The PE segments are pendent groups. The graft copolymer is described by the following equation:

^{w}PEₓ-g-_{y}iPP_{z},

where w is the overall molecular weight (in kDa), x is the average graft spacing (in kDa), z is the graft size (in kDa), and y is the average graft number.

The iPP segment of the graft copolymer may have various sizes (e.g., length (e.g., number of repeat units) and weight). The portion of the iPP segment between each PE segment may be 1-100 kDa, including all 0.1 Da values and ranges therebetween (e.g., 1-50 kDa). Each portion of the iPP segment may be the same length (e.g., number of repeat units) and weight or may have different lengths (e.g., number of repeat units) and weights. For example, one or more portion(s) of the iPP segment have the same length and weight and one or more portion(s) of the iPP segment have different lengths and weights. In various examples, the iPP segments may have stereochemical or regioisomeric errors.

A graft copolymer may a various number of PE segments. A graft copolymer may have an average of 1-50 PE segments, including all 0.1 values and ranges therebetween. Each PE segment may have the same or different number average molecular weight (Mₙ). An PE segment may have an Mₙ of 1-100 kDa, including all 0.1 Da values and ranges therebetween (e.g., 1-50 kDa). For example, one or more PE segment(s) have the same length and weight and one or more PE segment(s) have different lengths and weights.

A graft copolymer may have the following structure:

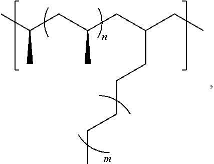

where m is 36 to 3600, including all integer values and ranges therebetween, and n is 24 to 1200, including all integer values and ranges therebetween.

A graft copolymer of the present disclosure may have various end groups. An end group may be an aliphatic group (e.g., an alkenyl group, alkyl group, and the like). For example, an end group may be a methyl group or methylene group or a group formed from a monomer of the polymerization reaction (e.g., a group formed from an ethylene group and/or propylene group). For example, the end group may be unsaturated (e.g. an alkene) due to the catalyst termination mechanism. End groups on a graft copolymer may be the same or different.

In various examples, the segments may further comprise one or more additional groups (e.g., contaminants). For example of additional groups (e.g., contaminants, which may be referred to as “contaminant groups”), a PE segment may comprise one or more polypropylene group(s) and/or one or more comonomer group(s). For example, an iPP segment may comprise one or more ethylene groups and/or one or more comonomer(s). In various examples, there is 0 mol % contaminants. In various examples, there is less than or equal 1 mol % contaminants, less than or equal 2 mol % contaminants, less than or equal 3 mol % contaminants, less than or equal 4 mol % contaminants, less than or equal 5 mol % contaminants, less than or equal 6 mol % contaminants, less than or equal 7 mol % contaminants, less than or equal or equal 8 mol % contaminants, less than or equal 9 mol % contaminants, less than or equal 10 mol % contaminants, less than or equal 11 mol % contaminants, less than or equal 12 mol % contaminants, less than or equal 13 mol % contaminants, less than or equal 14 mol % contaminants, less than or equal 15 mol % contaminants, less than or equal 16 mol % contaminants, less than or equal 17 mol % contaminants, less than or equal 18 mol % contaminants, less than or equal 19 mol % contaminants, less than or equal 20 mol % contaminants, less than or equal 21 mol % contaminants, less than or equal 23 mol % contaminants, less than or equal 24 mol % contaminants, or less than or equal to 25 mol % contaminants

In an aspect, the present disclosure provides polymer blends (e.g., graft copolymer blends). The polymer blends may be a blend of a graft copolymer of the present disclosure and one or more semi-crystalline polyethylene(s), a graft copolymer of the present disclosure and one or more iPP(s), or a graft copolymer of the present disclosure and one or more semi-crystalline polyethylene(s) and one or more iPP(s).

Various semi-crystalline polyethylenes may be used in a polymer blend (e.g., graft copolymer blend). Non-limiting examples of semi-crystalline polyethylenes include low-density polyethylene (LDPE), linear low-density polyethylene (LLDPE), high-density polyethylene (HDPE), medium-density polyethylene (MDPE), ultra-high-molecular-weight polyethylene (UHMWPE), derivatives/analogs of any of the foregoing, and the like, and combinations thereof.

A polymer blend of the present disclosure may comprise a graft copolymer of the present disclosure and a semi-crystalline polyethylene (e.g., HDPE) or a graft copolymer of the present disclosure isotactic polypropylene (iPP) or a graft copolymer of the present disclosure and one or more semi-crystalline polyethylene(s) (e.g., HDPE) and one or more iPP(s). Without intending to be bound by any particular theory, the graft copolymers act as compatibilizers. A polymer blend may comprise 0.1 to 20 wt % of the graft copolymer, including all 0.1 wt % value and range therebetween (e.g., 0.1-10 wt % or 0.1-5 wt %) (e.g., 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %), relative to the total weight of the polymer blend. Without intending to be bound by any particular theory, polymer blends may show enhanced tensile strength with a graft copolymer loading of 0.1 to 10 wt % of the graft copolymer, including all 0.1 wt % value and range therebetween (e.g., 0.1-5 wt % or 1 wt % or 5 wt %), relative to the total weight of the polymer blend.

A polymer blend may comprise various domains. The domains may by crystalline, semi-crystalline, or amorphous.

A polymer blend comprising a graft copolymer of the present disclosure and one or more semi-crystalline polyethylene(s) and one or more iPP(s) may have various weight ratios (w/w) of iPP to semi-crystalline polyethylene (e.g., iPP/PE). The iPP/PE ratio may be 1/99 to 99/1, including all ratio values and ranges therebetween (e.g., 99/1, 95/5, 90/10, 80/20, 70/30, 60/40, 50/50, 40/60, 30/70, 20/80, 10/90, 5/95, or 1/99) (e.g., 30/70 iPP/PE, such as, example 30/70 iPP/HDPE).

In an aspect, a graft copolymer is prepared by a method of the present disclosure. A method may comprise polymerization of iPP and ethylene.

A method of making a graft copolymer may comprise forming a reaction mixture comprising one or more macromonomer(s) (e.g., iPP macromonomer(s)) and a solvent, heating the reaction mixture, adding a monomer (e.g., ethylene through, for example, a monomer feed, where the reaction mixture is pressurized to 1 to 2000 psig, including every 0.1 psig value and range therebetween (e.g., 1-1500 psig, 1-1000 psig, 1-500 psgi, 1-300 psig, 1-100 psig)), adding a catalyst and, optionally, a cocatalyst to the reaction mixture, and, optionally, quenching the reaction (e.g., adding a quenching agent (e.g., methanol) to the reaction mixture). In various examples, the macromonomer may be formed in situ when forming the graft copolymer. In various examples, the various components in the reaction mixture (e.g., macromonomer, monomer, catalyst, co-catalyst, and solvent) are added in any order.

A macromonomer may be made by various methods known in the art. For example, macromonomers may be produced using catalysts that undergo β-methyl elimination in the homopolymerization of propylene. Such methods are disclosed in JP2009299045A and the sections pertaining to homopolymerization of propylene are incorporated herein by reference.

Various catalysts and/or cocatalysts and/or catalyst and cocatalyst combinations may be used. A catalyst may be any catalyst capable of alkene polymerization, non-limiting examples include metallocene catalysts or non-metallocene catalysts (e.g. pyridylamidohafnium catalyst), and the cocatalyst (e.g., activators) may be methylalumoxane, N,N-dimethylanilinium borate salts, trityl borate salts, and/or Lewis acids (e.g. B(C₆F₅)₃ and the like), and the like, and combinations thereof.

In an illustrative example, a graft copolymer may be prepared by copolymerization of iPP macromonomers with ethylene using an pyridylamidohafnium precatalyst and B(C₆F₅)₃. Copolymerization may occur at a temperature of about 70° C.

In various examples, copolymerization may be quenched prior to full macromonomer consumption. The amount of macromonomer incorporation may range from 10 to 99%, including all 0.1% values and ranges therebetween (e.g., 10 to 65%). In various other examples, either the copolymerization may proceed to completion, where the macromonomer (e.g., iPP macromonomer) is fully consumed, the monomer (e.g., ethylene) is fully consumed, or both the macromonomer and the monomer are fully consumed.

The present disclosure describes preparing graft copolymers via a “grafting through” approach; however, other methods of producing the graft copolymers may be used. For example, the methods of the present disclosure can be modified for “graft to” methods and “graft from” methods. Such modifications will be apparent to one having ordinary skill in the art. For example, additional methods of preparing a graft copolymer are in Brant et al., Macromolecules 2020, 53 (15), 6353-68 and the portion relating to the synthesis of graft copolymers is incorporated herein by reference.

In an aspect, the present disclosure provides a method of making a polymer blend (e.g., a graft copolymer blend). A graft copolymer blend may be prepared by melt-blending a graft copolymer of the present disclosure with semi-crystalline polyethylene or a graft copolymer of the present disclosure with iPP or a graft copolymer of the present disclosure with iPP and semi-crystalline polyethylene.

A method of melt-blending may comprise forming a reaction mixture of iPP and a graft copolymer of the present disclosure or semi-crystalline polyethylene (e.g., HDPE) and a graft copolymer of the present disclosure or iPP and semi-crystalline polyethylene (e.g., HDPE) and a graft copolymer of the present disclosure. The graft copolymer may have a concentration of 0.1 to 20 wt %, including all 0.1 wt % value and range therebetween (e.g., 0.1-10 wt % or 0.1-5 wt %) (e.g., 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %), relative to the total weight of the polymer blend. The reaction mixture may then be heated and pressed (e.g., heating to 180° C.) for a period of time (e.g., 5 minutes), such that a coherent film is formed. The film may then be fed through a compounder (e.g., a twin screw compounder, which may be a microcompounder, such as, for example, a twin screw microcompounder) with heating (e.g., 190° C.) with a flow of an inert gas (e.g., argon) and a particular residence time (e.g., 8 minutes at 130 rpm). The resulting material may then be extruded through a die (e.g., various die molds may be used, such as, for example, a 2.5 mm diameter die) and cooled, resulting in a blend. The blend may then be pressed with heating (e.g., 180° C.) for a period of time (e.g., 5 minutes).

The hot polymer blend may be cooled at various rates. Without intending to be bound by any particular theory, it is considered that cooling the heated polymer blend at a fast rate results in a polymer blend with desirable features (e.g., high tensile strength). For example, the melt-blended graft copolymer blend is cooled at 5° C./min to 30° C./min, including every 0.1° C./min value and range therebetween (e.g., 10° C./min to 25° C./min or 23° C./min); however, cooling is not limited to rates within this range. Cooling rates may vary depending on the size and shape of the polymer blend (e.g., article comprising the polymer blend). In various examples, the hot polymer blend is cooled at 1° C./hr to 100° C./min. Without intending to be bound by any particular theory, it is considered that faster cooling prevents phase separation in the polymer blend (e.g., phase separation of iPP) and thus imparts high tensile strength.

In various examples, a polymer blend of the present disclosure may be “recycle ready.” For example, a polyethylene article or polypropylene material may be used in a method of the present disclosure such that the article may be recycled. For example, a recycle ready polyethylene article can comprise a blend comprising polyethylene and a graft copolymer, such that the recycle ready polyethylene article can enter a recycle stream and be readily blended with recycled polypropylene to produce a blend. For example, a recycle ready polypropylene article can comprise a blend comprising polypropylene and a graft copolymer, such that the recycle ready polypropylene article can enter a recycle stream and be readily blended with recycled polyethylene to produce a blend.

In an aspect, the present disclosure provides articles of manufacture. The articles of manufacture (e.g., articles) comprise a graft copolymer of the present disclosure or a polymer blend (e.g., graft copolymer blend) of the present disclosure.

An article of manufacture may comprise a graft copolymer of the present disclosure or a polymer blend (e.g., graft copolymer blend) of the present disclosure. An article of manufacture may be any three dimensional (3D) shape. Examples of article of manufacture include, but are not limited to, vessels (e.g., cups, bottles, boxes, pails, coolers, and the like), lids/caps (e.g., screwcaps for bottles), chairs, tableware (e.g., dishes, forks, knives, spoons, and the like), traffic cones, bags, films, packaging materials, agricultural wrap, packing materials, toys, pipes, cable insulation, and the like. Such articles may be

The following Statements provide various examples and embodiments of the present disclosure.

Statement 1. A graft copolymer comprising: a semi-crystalline polyethylene (PE) segment; and a plurality of semi-crystalline isotactic polypropylene (iPP) segments, where each semi-crystalline isotactic polypropylene segment is covalently bonded to the semi-crystalline polyethylene segment and the iPP segments are pendent groups.
Statement 2. A graft copolymer according to Statement 1, where the number average molecular weight (Mₙ) of the graft copolymer is 25-1000 kDa, including all integer values and ranges therebetween (e.g., 50-500 kDa).
Statement 3. A graft copolymer according to Statements 1 or 2, where the number average molecular weight (Mₙ) of the portion of the PE segment between each iPP segment is 1-100 kDa, including all 0.1 Da values and ranges therebetween.
Statement 4. A graft copolymer according to any one of the preceding Statements, where the average number of iPP segments is 1-50, including all 0.1 values and ranges therebetween.
Statement 5. A graft copolymer according to any one of the preceding Statements, where the number average molecular weight (Mₙ) of the iPP segments is 1-50 kDa, including all integer values and ranges therebetween.
Statement 6. A graft copolymer according to any one of the preceding Statements, where the number average (Mₙ) molecular weight of the iPP segments is about 6 kDa and average number of iPP segments is about 16.
Statement 7. A graft copolymer according to any one of the preceding Statements, where the graft copolymer comprises the following structure:

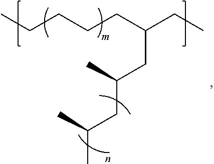

where m is 36 to 3600, including all integer values and ranges therebetween, and n is 24 to 1200, including all integer values and ranges therebetween.
Statement 8. A graft copolymer according to any one of the preceding Statements, the graft copolymer end groups are saturated or unsaturated aliphatic groups. In various examples, the PE chain may contain some propylene or other comonomer and/or one or more of the iPP segment(s) may contain some ethylene or other comonomer.
Statement 9. A graft copolymer blend comprising one or more graft copolymer(s) according to any one of the preceding Statements and one or more semi-crystalline polyethylene(s) or one or more graft copolymer(s) according to any one of the preceding Statements and one or more isotactic polypropylene(s) (iPP(s)) or one or more graft copolymers according to any one of the preceding Statements and one or more semi-crystalline polyethylene(s) and one or more iPP(s).
Statement 10. The graft copolymer blend according to Statement 9, wherein the iPP/semi-crystalline polyethylene ratio is 1/99 to 99/1 (w/w) (e.g., 30/70 (w/w)) (e.g., 99/1, 95/5, 90/10, 80/20, 70/30, 60/40, 50/50, 40/60, 30/70, 20/80, 10/90, 5/95, or 1/99 (w/w)). Statement 11. The graft copolymer blend according to Statements 9 or 10, wherein the total concentration of the one or more graft copolymer(s) is 0.1 to 20 wt % relative to the total weight of the graft copolymer blend, including all 0.01 wt % values and ranges therebetween (e.g., 0.1-10 wt % or 0.1-5 wt %) (e.g., 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt %).
Statement 12. The graft copolymer blend according to any one of Statements 9-11, wherein the one or more semi-crystalline polyethylene is HDPE and has a molecular weight (e.g., Mₙ and/or M_{w}) of 10-1000 kDa, including all 0.1 Da values and ranges therebetween. Statement 13. The graft copolymer blend according to any one of Statements 9-12, wherein the one or more iPP(s) has a molecular weight (e.g., Mₙ and/or M_{w}) of 10-1000 kDa, including all 0.1 Da values and ranges therebetween.
Statement 14. A method of making a graft copolymer comprising: forming a reaction mixture comprising: one or more iPP macromonomer(s) and a solvent; dissolving the iPP macromonomer; heating the reaction mixture; adding ethylene to the reaction mixture; adding a catalyst and, optionally, a cocatalyst to the reaction mixture; and quenching the reaction (e.g., by adding a quenching agent to the reaction mixture), wherein the graft copolymer is produced. The iPP macromonomer may be made in situ. The graft copolymer may be isolated (e.g., isolated by filtration). The macromonomer, monomer, catalyst, and cocatalyst may be added in any order.
Statement 15. A method according to Statement 15, where the iPP macromonomer has the following structure:

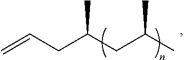

wherein n is 24 to 1200, including all integer values and ranges therebetween.
Statement 16. A method according to any one of Statements 14 or 15, where the ethylene is added such that the reaction mixture is pressurized to a pressure of 1 to 300, including every 0.1 psig value or range therebetween, (e.g., 1-100 psig). In various examples, the reaction mixture is set up with nitrogen present.
Statement 17. A method according to any one of Statements 14-16, wherein the catalyst is an alkene polymerization catalyst. The alkene polymerization catalyst may be one or more metallocene catalyst(s) and/or one or more non-metallocene catalyst(s). The non-metallocene catalyst may be a pyridylamidohafnium catalyst. The cocatalyst may be chosen from methylalumoxane, N,N-dimethylanilinium borate salts, trityl borate salts, Lewis acids (e.g., B(C₆F₅)₃ and the like), and combinations thereof.
Statement 18. A method according to any one of Statements 14-17, where the quenching agent is methanol.
Statement 19. A method according to any one of Statements 14-18, where polymerization of the ethylene and the iPP macromonomer is quenched prior to consumption of all of the iPP macromonomer.
Statement 20. A method according to any one of Statements 14-19, where 10 to 99%, including every 0.1% value and range therebetween (e.g., 10 to 65%), of the iPP macromonomer is incorporated into the graft copolymer.
Statement 21. A method of making a graft melt-blending the one or more graft copolymer(s) with one or more semi-crystalline polyethylene(s) (e.g., HDPE) or the one or more graft copolymer(s) with one or more iPP(s) or the one or more graft copolymer(s) with one or more semi-crystalline polyethylene(s) (e.g., HDPE) and one or more iPP(s), where the graft copolymer blend is formed.
Statement 22. A method according to Statement 21, where the melt-blended graft copolymer blend is cooled at 1° C./hr to 100° C./min, including every 0.1° C./min value and range therebetween (e.g., 5° C./min to 30° C./min or 10° C./min to 25° C./min). Statement 23. An article of manufacture comprising a graft copolymer blend according to any one of Statements 9-12.

The following example is presented to illustrate the present disclosure. It is not intended to be limiting in any matter.

### EXAMPLE

The following example provides a description of methods of preparing graft copolymers and polymer blends.

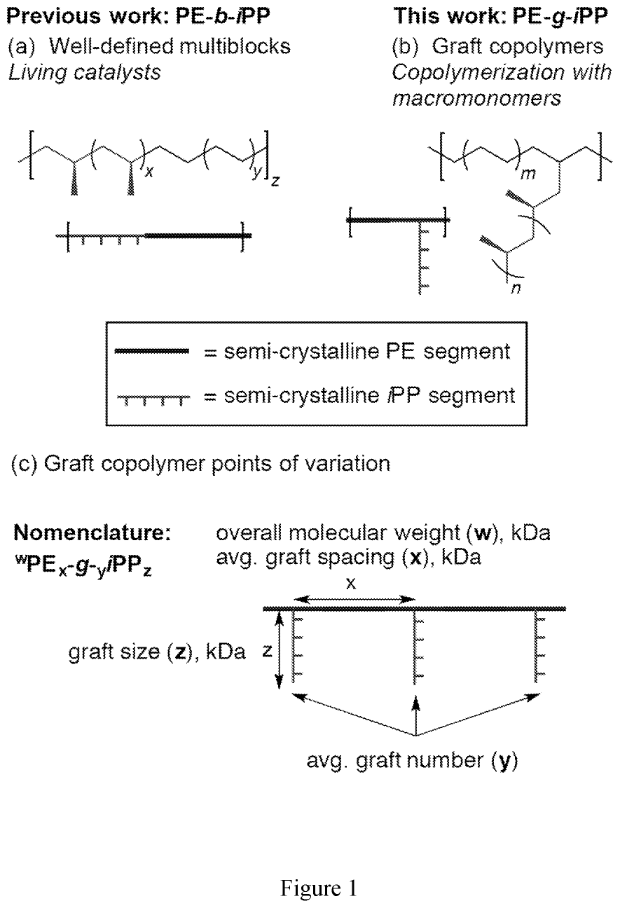

It was envisioned that PE-g-iPP graft copolymers (FIG. 1b) might be suitable compatibilizers and permit the use of non-living polymerizations for both the production of the macromonomer and graft copolymer, resulting in a viable alternative to living polymerization. Important variables for GCPs include iPP graft length, number of grafts per chain, average distance between grafts, branch distribution and backbone length. (FIG. 1c). The results are described herein.

A series of allyl-terminated iPP macromonomers were prepared using an ansa-metallocene catalyst which can undergo β-chloride elimination in the presence of a vinyl chloride chain transfer agent. The macromonomers were characterized by gel-permeation chromatography (GPC) and were prepared over a range of molecular weights (Mₙ=6-28 kg/mol) by varying the amount of vinyl chloride added (Table 2).

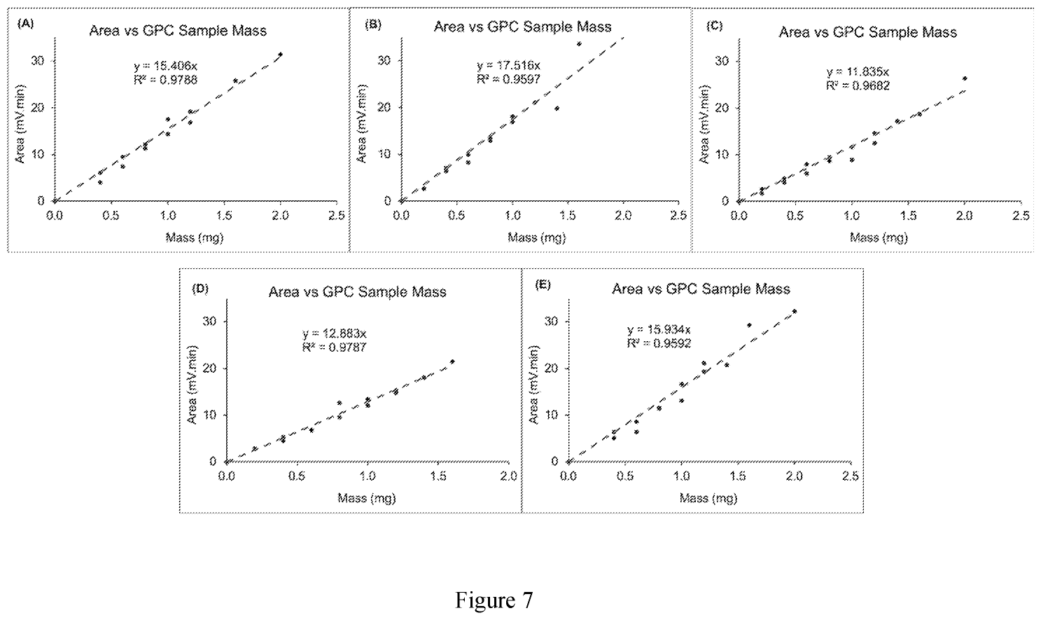

A series of graft copolymers was prepared by copolymerization of the iPP macromonomers with ethylene (Table 1) using a pyridylamidohafnium precatalyst (1) and B(C₆F₅)₃. To ensure macromonomer and graft copolymer solubility, the copolymerizations were run at 70° C. and the reaction was quenched prior to full macromonomer consumption to help minimize tapering in the resulting graft copolymers. GPC curve fitting was used to estimate the amount of residual unreacted macromonomer in the mixture and to calculate the average number of grafts incorporated per polymer chain; the amount of macromonomer incorporated ranged from 12-60%. A full description of the residual macromonomer quantification provided below (FIG. 7, 8 and Table 3).

TABLE 1
Synthesis and characterization of graft copolymers.

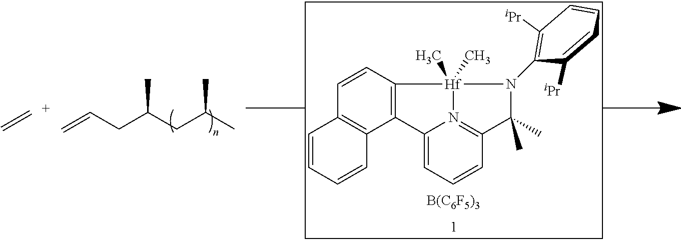

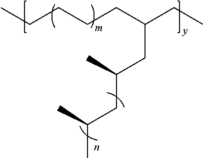

| | | iPP | | | | MM | | |
|---|---|---|---|---|---|---|---|---|
| | | MM | Mass | C₂H₄ | Yield | incorp. | Graft/ | |
| Entry | Sample^{b} | (kDa)^{c} | MM (g) | (psi) | (g) | (%)^{d} | chain^{e} | ε(%)^{f} |
| 1 | ¹⁸⁵PE_{5.2}-g-₁₆iPP₆ | 6 | 1.00 | 10 | 1.33 | 40 | 16 | 950 ± 50 |
| 2 | ²²¹PE₁₅-g-₁₀iPP₆ | 6 | 1.00 | 20 | 1.88 | 45 | 12 | 100 ± 60 |
| 3^{g} | ⁶³PE_{5.5}-g-_{5.0}iPP₆ | 6 | 1.00 | 10 | 1.20 | 21 | 5.9 | n.d.^{h} |
| 4 | ¹⁶⁴PE₁₃-g-_{5.5}iPP₁₄ | 14 | 0.50 | 10 | 0.73 | 40 | 5.5 | 57 ± 16 |
| 5 | ²¹⁰PE_{8.9}-g-_{8.8}iPP₁₄ | 14 | 0.75 | 10 | 1.04 | 53 | 8.8 | 850 ± 30 |
| 6 | ²⁶⁰PE_{8.8}-g-₁₁iPP₁₄ | 14 | 1.00 | 10 | 1.46 | 60 | 11 | 990 ± 80 |
| 7 | ²¹³PE₅₇-g-_{2.2}iPP₁₄ | 14 | 1.00 | 20 | 1.73 | 12 | 2.2 | 210 ± 20 |
| 8ⁱ | ³⁶⁴PE₇₄-g-_{2.9}iPP₂₆ | 26 | 1.00 | 10 | 1.99 | 26 | 2.9 | 17 ± 2 |
| 9ⁱ | ²⁹⁸PE₃₀-g-_{4.6}iPP₂₈ | 28 | 1.50 | 10 | 2.05 | 29 | 4.6 | 31 ± 4 |
| 10ⁱ | ³⁹⁸PE₁₅-g-_{9.3}iPP₂₆ | 26 | 2.00 | 10 | 2.52 | 40 | 9.3 | 910 ± 80 |
| 11ⁱ | ⁴¹³PE₃₉-g-_{5.6}iPP₂₈ | 28 | 2.00 | 20 | 3.08 | 33 | 5.6 | 620 ± 180 |
| 12^{g,i} | ³²⁰PE_{9.8}-g-_{8.2}iPP₂₈ | 28 | 2.00 | 10 | 2.36 | 46 | 8.2 | 910 ± 70 |

aGeneral conditions: 10.0 μmol 1, 10.5 μmol B(C₆F₅)₃, 50 mL PhMe, 0.50 to 2.00 g of macromonomer (MM), Tᵣₓₙ = 70° C., 30 min.
bGraft copolymer nomenclature: ^{w}PEₓ-g_{y}iPP_{z}, where w = Mₚ of the polymer, x = Mₙ of the average PE spacers, y = average iPP grafts per chain, z = Mₙ of iPP macromonomer (See below for calculation details).
cDetermined by GPC relative to polyethylene standards at 150° C. in 1,2,4-trichlorobenzene.
dCalculated from area of the unreacted MM using area vs. GPC sample mass plot (Sec SI for details).
eCalculated as moles of macromonomer incorporated divided by the moles of graft copolymer.
fε = average strain at break and standard deviation (%) for HDPE/iPP 70/30 blends with 5 wt % graft copolymer additive determined at fracture using uniaxial tensile test. Tensile bars were cooled at 10° C./min after melt-pressing. (HDPE: ε = 1180 ± 170 %. iPP: ε = 560 ± 50%. HDPE/PP 70/30: ε = 17 ± 1%.)
gCopolymerization time = 15 min.
hn.d. = not determined.
i100 mL of toluene.

The number of grafts incorporated into the chain can be tuned by adjusting the macromonomer concentration in the polymerization (Table 1, entries 4-6, 8-10). The polyethylene weight fraction can be tuned by varying the ethylene pressure (Table 1, entries 1 vs. 2; 6 vs. 7; 10 vs. 11). To determine if the grafts were randomly distributed along the main polymer chain, control experiments were performed by stopping the polymerization early. Polymer synthesized using this method contained fewer grafts per chain, suggesting that incorporation of macromonomer is continuous throughout the duration of the experiment (Table 1, entry 1 and 3). However, for the highest molecular weight macromonomers (Mₙ=26-28 kDa), we noticed that at high macromonomer concentration the number of grafts was unchanged from 15 min. to 30 min. reaction times (Table 1, entries 12 and 10, respectively), although the total molecular weight increased. It was hypothesized that the macromonomer coprecipitates with the growing polymer chain in these cases, inhibiting further incorporation. Since the majority of the high molecular weight macromonomer incorporation occurs towards the beginning of the polymerization, this may result in graft copolymers with a higher density of grafts located towards one end of the polymer chain.

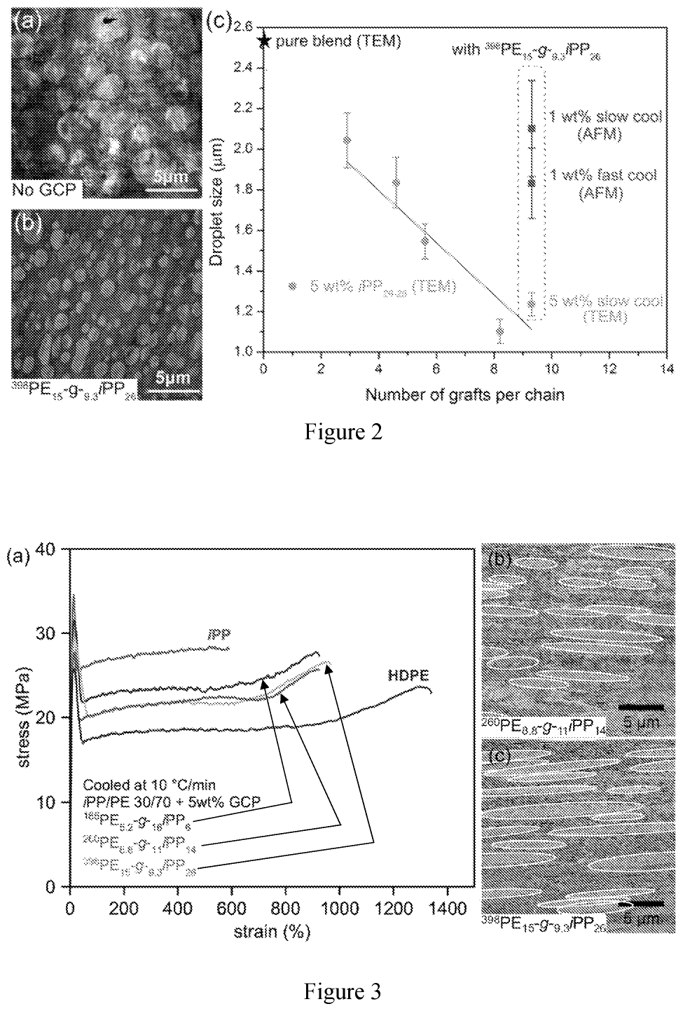

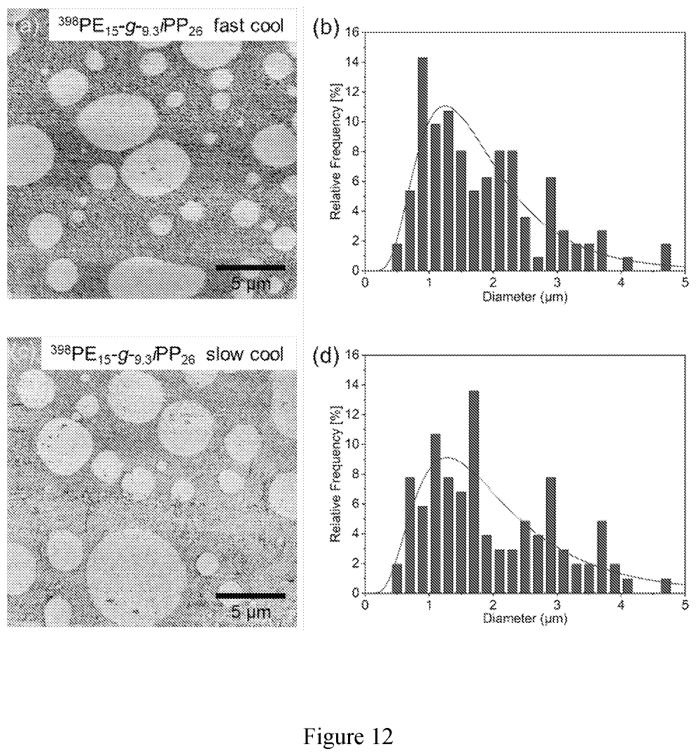

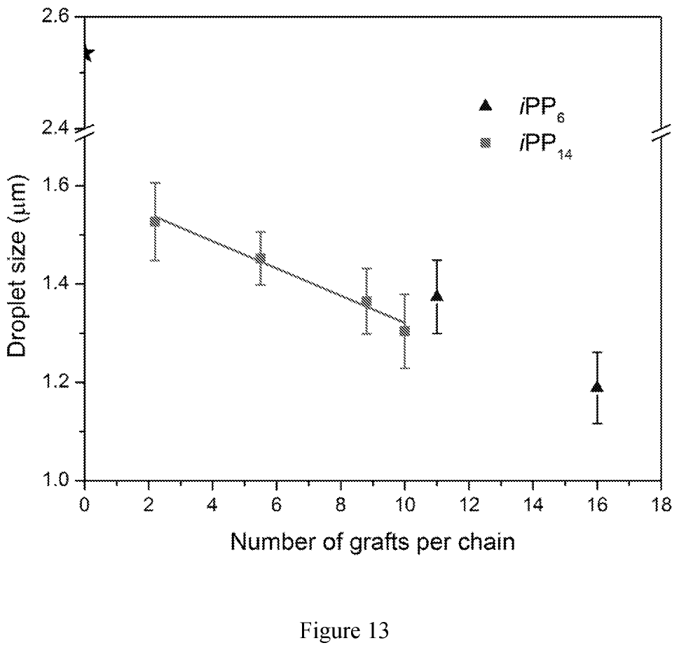

PP and HDPE homopolymers undergo phase separation when blended in the melt. To investigate the effect of GCPs on blend structure, mixtures of iPP and HDPE (iPP/HDPE=30/70 w/w) were melt-blended in the presence of graft copolymer (5 wt %). The morphology of the mixtures was imaged by transmission electron microscopy (TEM). The blends were stained with a RuO₄ solution and then cryomicrotomed. Representative TEM micrographs are shown in FIG. 2 and FIGS. 10-11, where the iPP minority phase appears as brighter islands in the HDPE matrix. For a given graft length, samples with larger number of grafts per chain exhibit smaller dispersed phases (FIG. 2c). For the blend containing 5 wt % % iPP₂₆₋₂₈ₖ GCP, the average iPP domain diameter decreased from 2.5 to 1.2 μm as the average number of grafts/chain increased from 0 to 9 grafts/chain. Similar results were observed for the iPP₁₄ and iPP₆ grafts (FIG. 13). For comparison to 5 wt % GCP, the iPP droplet size of blend samples containing 1 wt % ³⁹⁸PE₁₅-g-_{9.3}iPP₂₆ GCP were analyzed by atomic force microscopy (AFM) (FIG. 12). The average droplet size was ca. 2 μm, with a slightly smaller average droplet size observed when the sample was cooled at 23° C./min vs 10° C./min (vide infra) after melt pressing, possibly due to additional domain coarsening during the slow cooling. All these results show that properly designed GCPs drive reductions in the dispersed phase droplet size, presumably by localizing at the interface and reducing the interfacial tension of the iPP/HDPE blends, in a manner typical of a good compatibilizer.

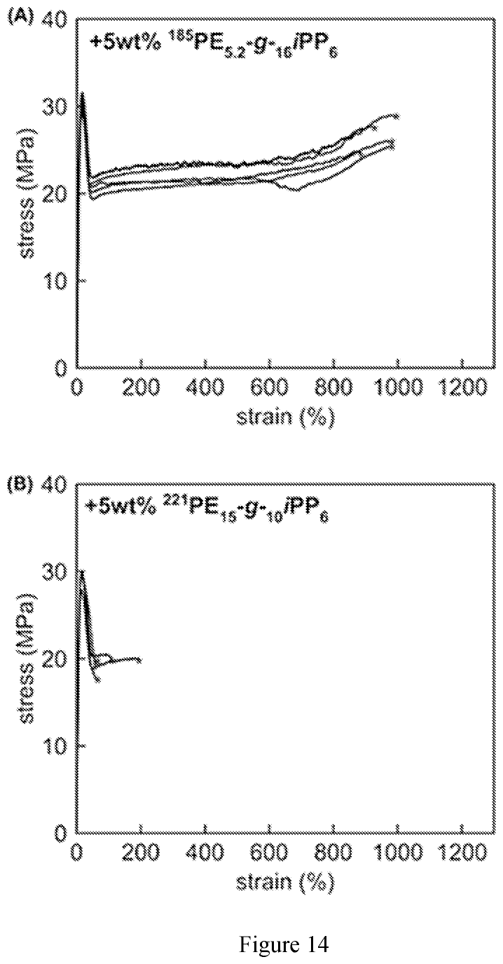

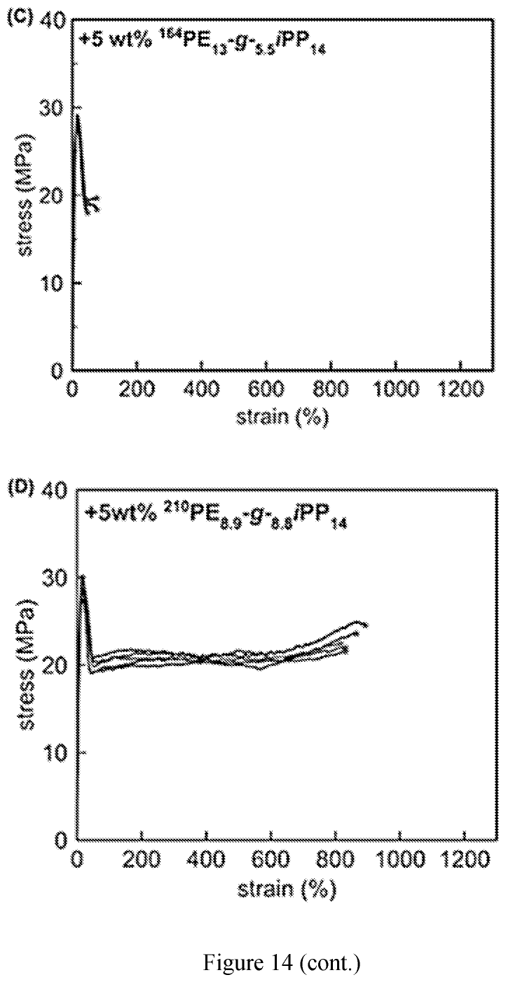

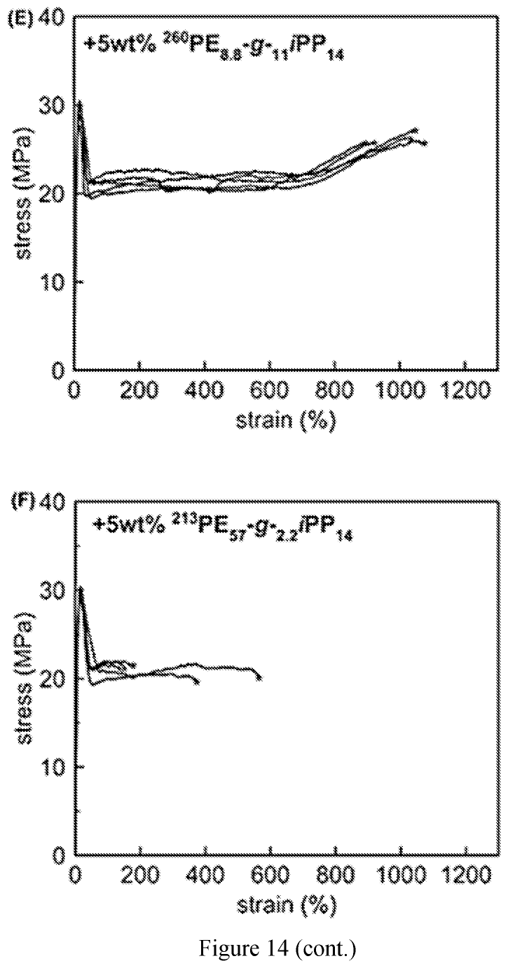

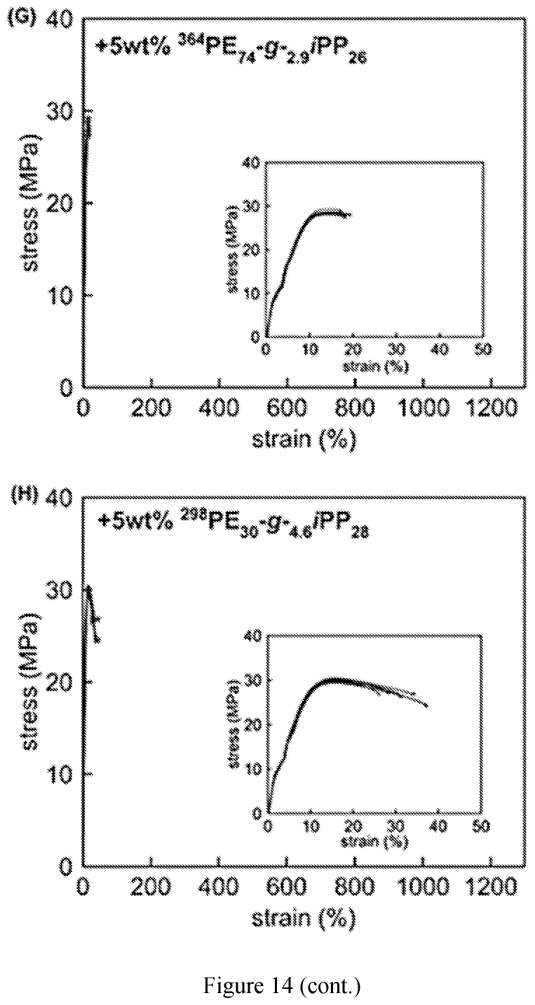

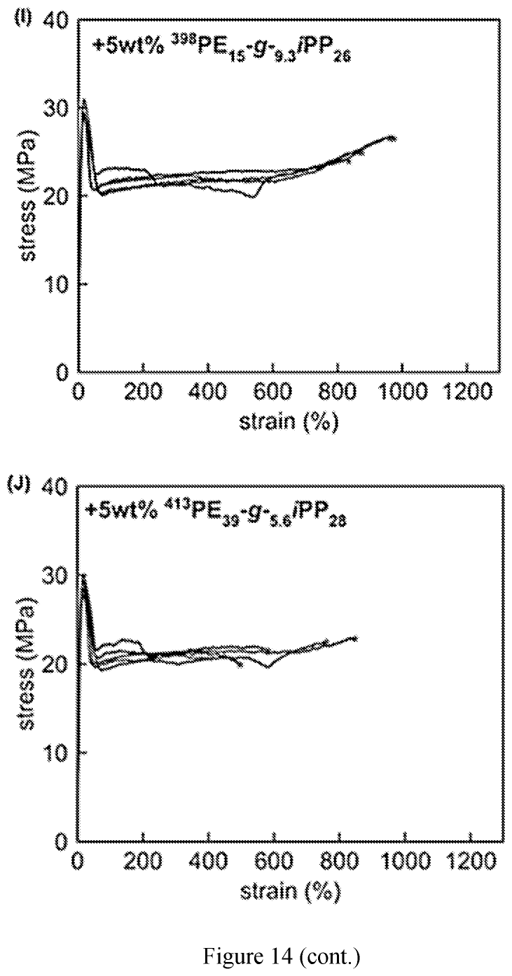

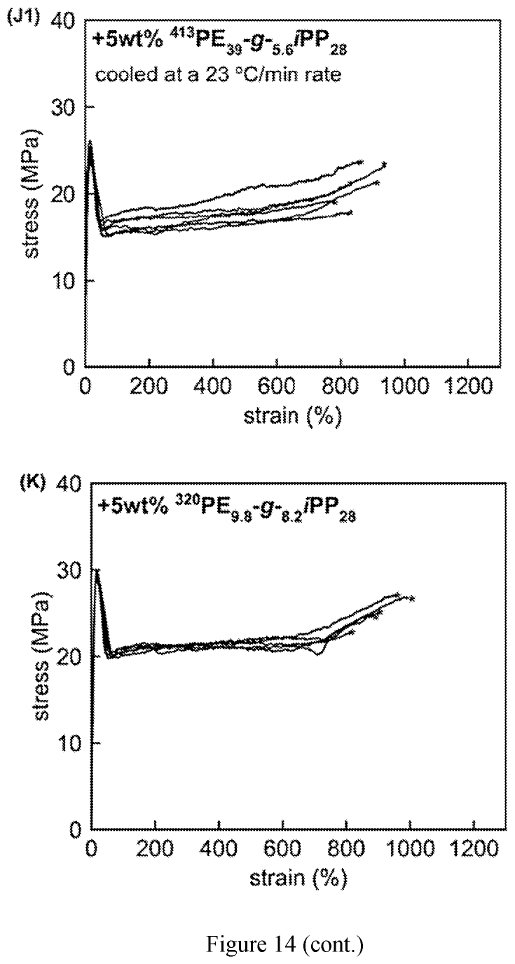

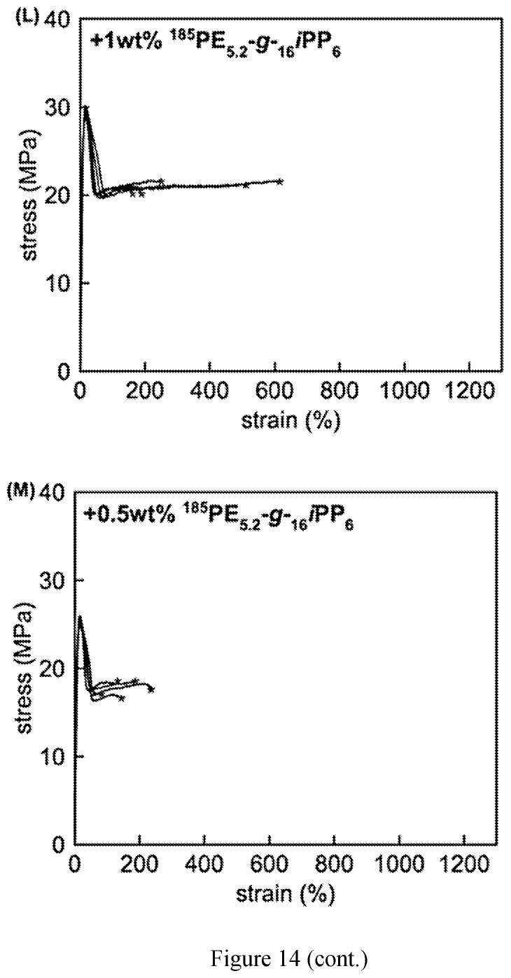

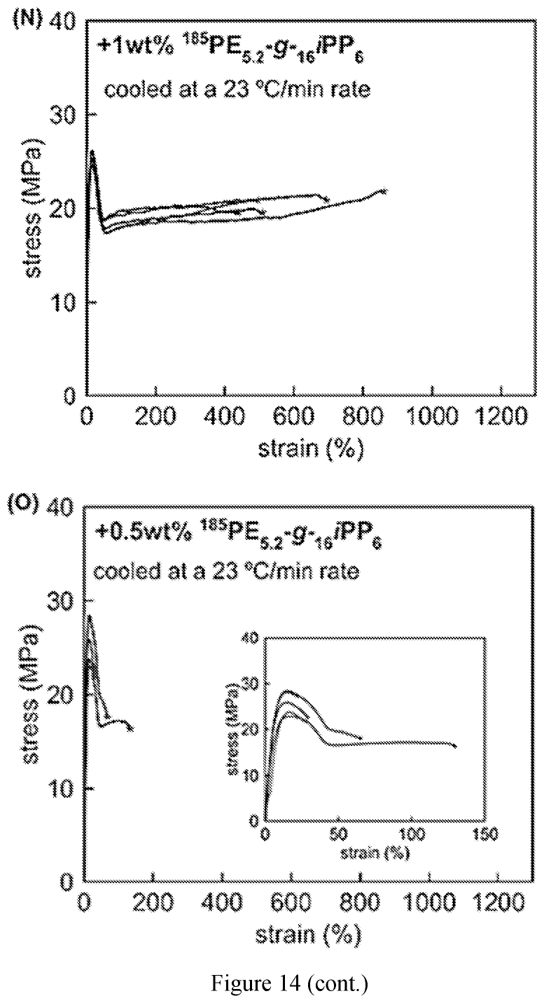

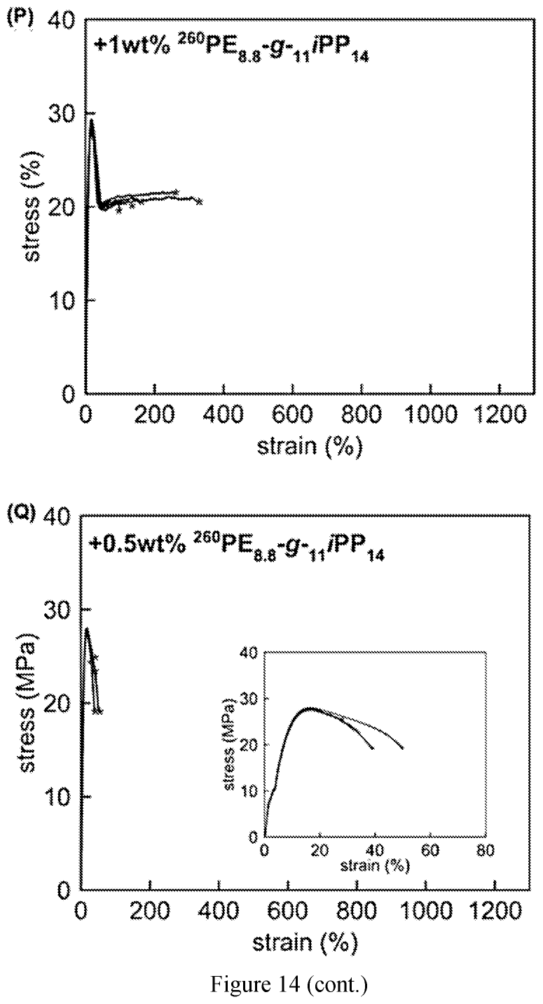

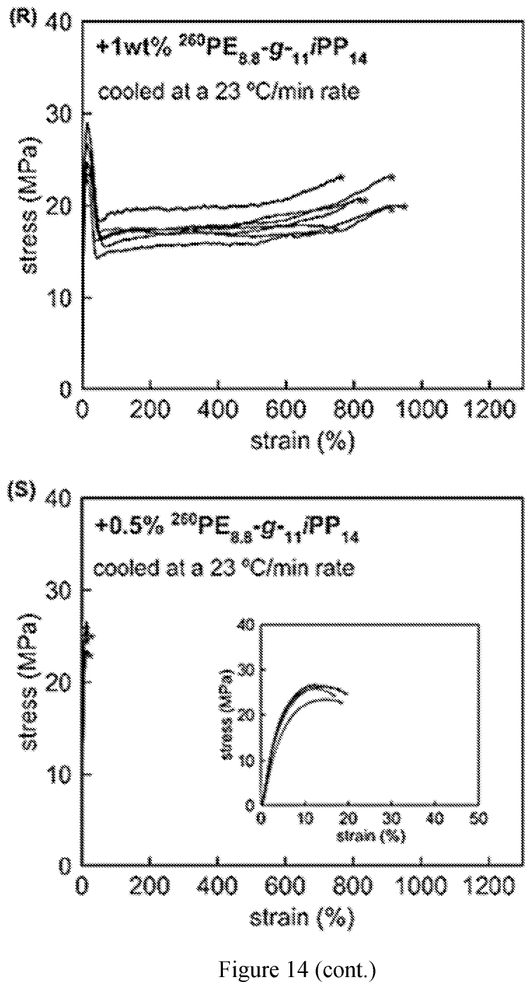

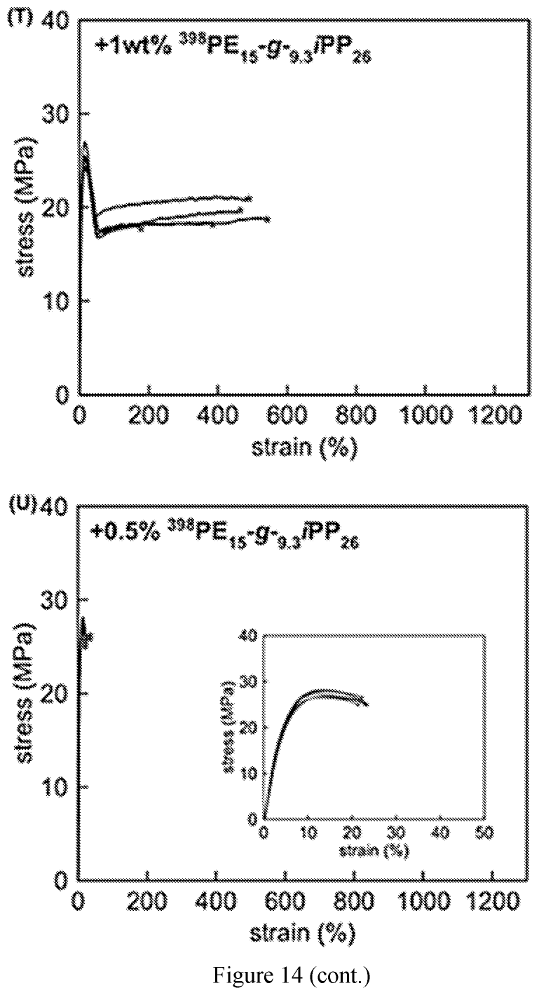

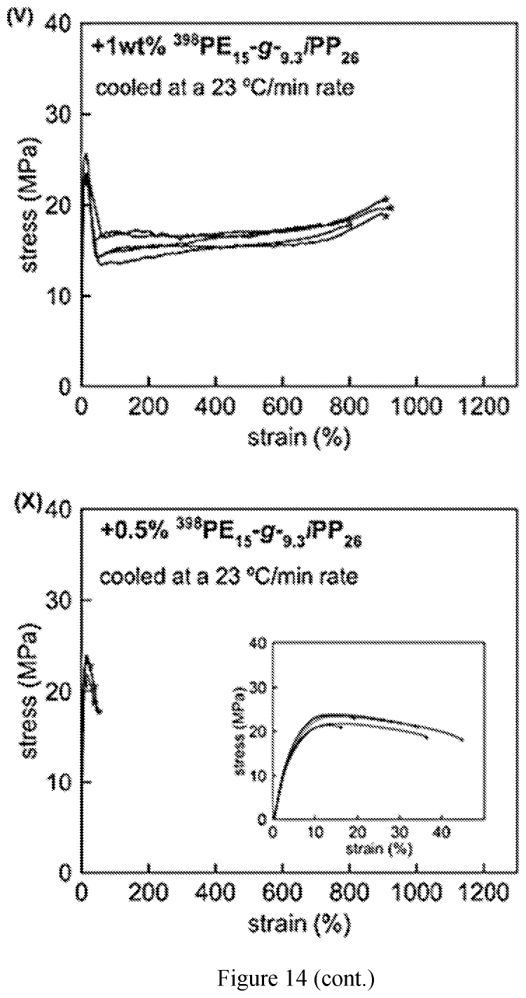

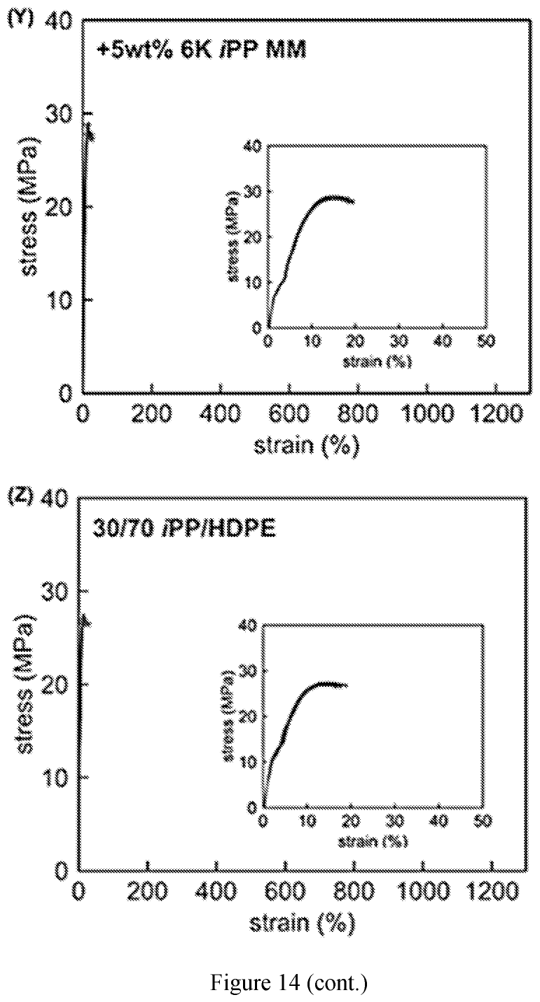

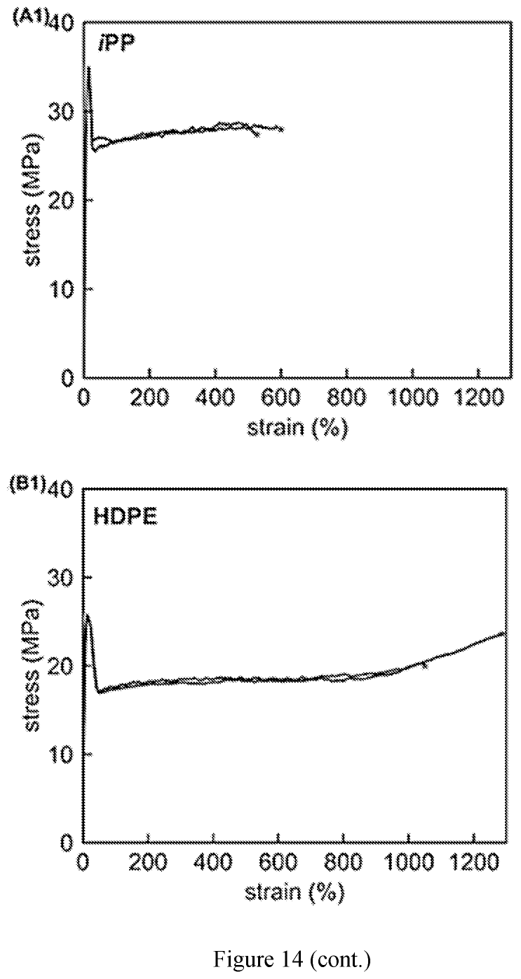

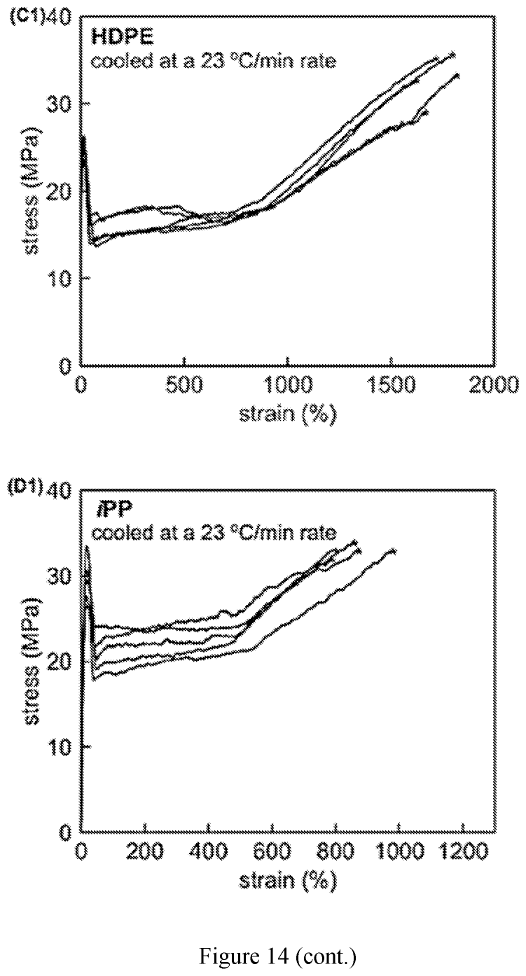

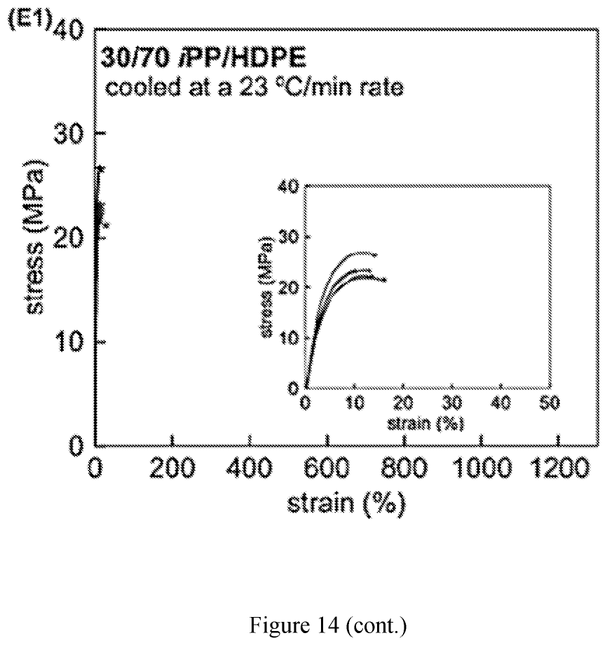

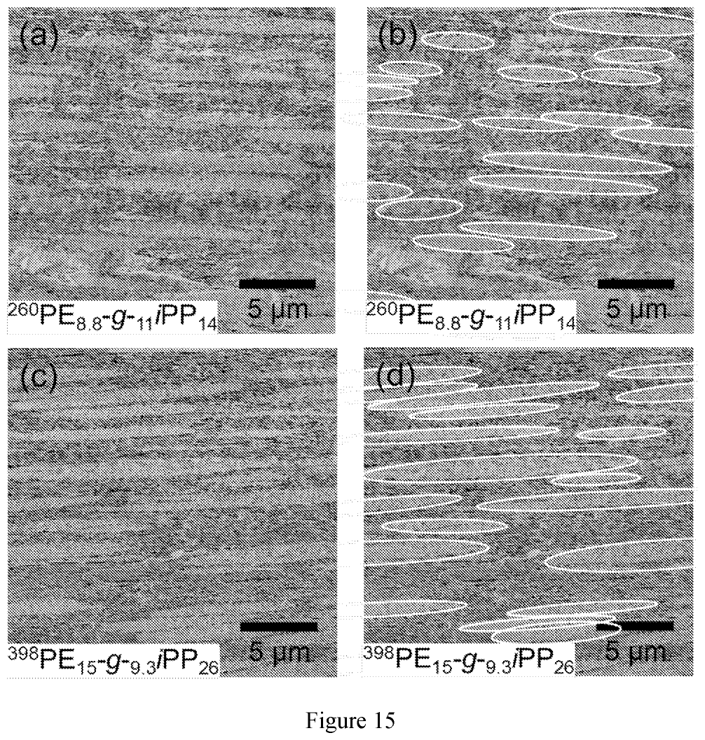

Individually, the iPP and HDPE homopolymer samples employed herein displayed ductile behavior (i.e. >600% strain at break) with strain hardening at larger elongations (FIG. 14 panels A1, B1, C1 and D1). However, when these polymers are meltblended (iPP/HDPE=30/70 w/w) without compatibilizer, the resulting mixture shows a reduction in ductility (i.e. <20% strain at break) compared to the neat materials (FIG. 14 panel Z and E1). Ideally, the tensile behavior (i.e., elongation and toughness) of compatibilized blends should be intermediate to that of the HDPE and iPP homopolymers, a feature that would be indicative of a good compatibilizer. To test the effectiveness of the GCPs, the mechanical properties of iPP/HDPE blends were first evaluated with 5 wt % GCP (FIGS. 3a and 14); this relatively high GCP loading was selected to probe the effect of the graft length and density. For all three graft lengths, improved elongation was achieved in blends compatibilized with graft copolymers containing a larger number of grafts (FIG. 3a). As an example, for the GCP's containing the 6 kDa iPP grafts, the strain at break increased from 100% to 950% in strain at break when the average number of grafts per chain was raised from 10 (FIG. 14 panel B) to 16 (FIGS. 3a and 14 panel A). For two of the samples in FIG. 3a, it is noteworthy that AFM images (FIGS. 3b and 3c, 15) of cross-sections near (i.e., within 1 cm) the fracture surface showed that the iPP droplets deformed into highly extended ellipsoids elongated in the tensile direction. Qualitatively, it appears that the droplets deformed in a manner commensurate with the deformation of the HDPE matrix. There were no detectable voids indicative of cavitation at the interface between the deformed iPP droplets and the HDPE matrix. Without intending to be bound by any particular theory, it is considered that the GCPs localize at the interface and facilitate strong interfacial adhesion that can aid in stress transfer between the two phases; this observation is consistent with the toughness and high elongation of these compatibilized blends.

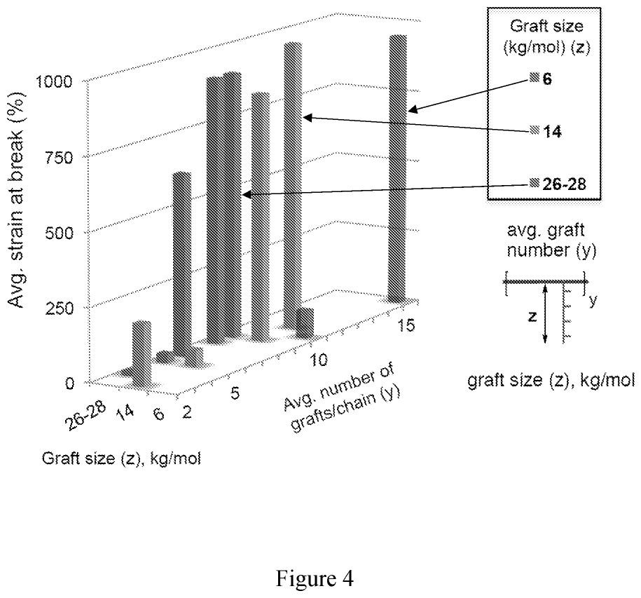

The effect of graft length on tensile properties was evaluated (FIG. 4). As the molecular weight of the grafts increased from 6 kDa to 26 kDa, the higher molecular weight macromonomer variants required fewer grafts to achieve improved toughness. Similar tensile properties were obtained with 16 grafts per chain of 6 kDa grafts (Table 1, entry 1) and 11 grafts per chain of 14 kDa grafts (Table 1, entry 6); for the 26 kDa grafts, high strain at break was observed for as few as an average of 5.6 grafts/chain (Table 1, entry 11).

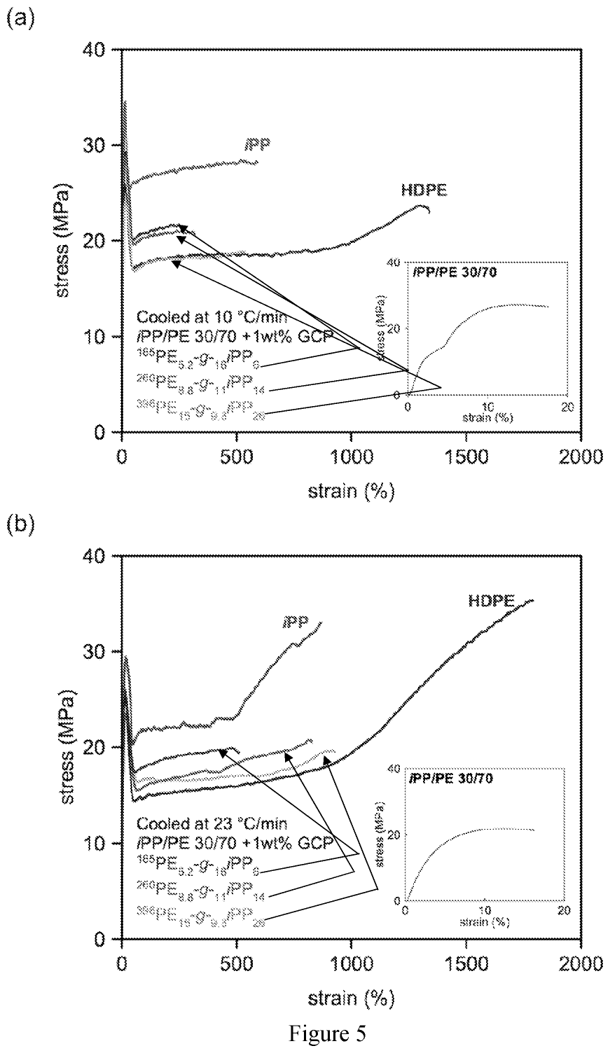

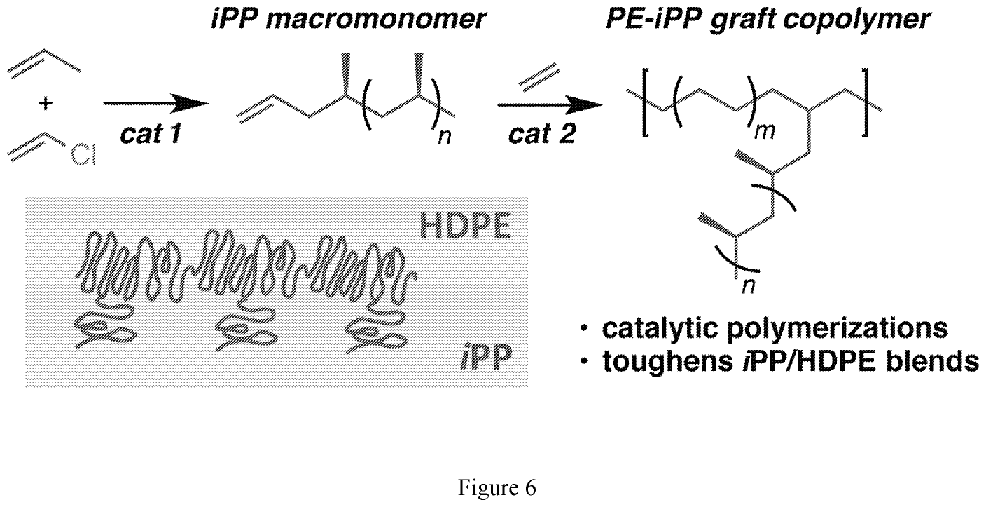

Having established the effect of the graft number and length, the mechanical compatibilization efficiency at lower loadings of graft copolymer was investigated. Under the base cooling conditions (10° C./min), blends containing 1 wt % GCP showed lower strain at break compared to the 5 wt % samples prepared with the same cooling rate (10° C./min, FIG. 5a). It was hypothesized that, at the lower GCP loading, there is less interfacial coverage of the GCP and therefore reduced ability to transfer stress across the interface.

Also investigated was the effect of cooling rate for the melt pressed samples on the tensile properties. At 1 wt % GCP loading, faster cooling (23° C./min) yielded samples with improved toughness relative to those cooled more slowly (10° C./min) (FIGS. 5b and 14). At 1 wt % ²⁶⁰PE_{8.8}-g-₁₁iPP₁₄ loading, the samples showed a strain at break of 800% compared to 250% at the slower cooling rate for the same additive. This is an anticipated result as slow cooling yields polymers with higher crystallinity and more brittle behavior, which is evident in the stress-strain curves for the pure iPP and HDPE (FIG. 5). For all the samples, with and without GCP, the modulus values (stress) between ca. 20% and 500-800% strain for the faster cooling rate (FIG. 5b) are ca. 15% lower than observed at the slower cooling rate (FIG. 5a). This likely reflects lower crystallinity at the faster cooling rate. iPP and HDPE homopolymers showed higher strain at break and more strain hardening when cooled at 23° C./min than at 10° C./min, also consistent with a higher rubbery amorphous content. However, the 30/70 iPP/HDPE blend showed similar, brittle, tensile behavior at both cooling rates (insets in Figure). The overall toughness of the best GCP containing blends is similar to that observed for blends containing linear PE-iPP tetra and hexablock copolymers.

The results from the tensile tests, TEM and AFM studies demonstrate that the PE-g-iPP copolymer additives act as good compatibilizers for iPP/HDPE blends. In general, increasing the number of grafts and increasing the graft length increases the tensile strength of compatibilized blends. As a comparison, the tensile strength for the rapidly cooled 1 wt % GCP containing blends is roughly comparable to that observed for well-defined PE-iPP tetra- and hexablocks. These findings suggest that efficient compatibilizers for HDPE and iPP may be prepared by non-living polymerization routes and may ultimately provide more economical syntheses of these useful materials.

General Considerations: All manipulations of air and/or moisture sensitive compounds were performed under a nitrogen atmosphere in MBraun Labmaster glovebox. The ¹H NMR and ¹³C{1H} NMR spectra were recorded on a 500 MHz Bruker AV III HD with broadband Prodigy Cryoprobe using the residual non-deuterated solvent signal as a reference [Cl₂CDCDCl₂ (d₂-TCE): 6.0 ppm (¹H), 73.78 ppm (¹³C)]. All polymer samples were analyzed in d₂-TCE in 5 mm tubes using quantitative ¹H and ¹³C{1H} NMR spectroscopy at 130° C. MestreNova software was used to process the spectra. High temperature gel permeation chromatography (GPC) was performed on Agilent PL-GPC 220 equipped with a refractive index (RI) detector and three PL-Gel Mixed B columns. GPC columns were eluted at 1.0 mL/min with 1,2,4-trichlorobenzene (TCB) containing 0.01 wt. % di-tert-butylhydroxytoluene (BHT) at 150° C. The samples were prepared in TCB (with BHT) at a concentration of 1.0 mg/mL unless otherwise stated and heated at 150° C. for at least 1 hour prior to injection. GPC data calibration was done with monomodal polyethylene standards from Varian and Polymer Standards Service. Differential scanning calorimetry (DSC) measurements were performed on Mettler Toledo Polymer DSC instrument. Polymer samples containing approximately 5 mg in crimped aluminum pans were prepared for each run. DSC samples were heated to 200° C. and maintained at the temperature for 10 min to erase the thermal history, followed by cooling to 20° C. and then heating back to 200° C. The cooling and heating process were kept at a rate of 10° C./min and in nitrogen atmosphere. The crystallization temperature (T_{c}) and the melting temperature (Tₘ) were obtained from the first cooling and second heating cycles respectively using the STARe software.

Compression molding was carried out using a 4120 Hydraulic Unit Carver press and stainless-steel die molds. Mylar protective sheets were obtained from Carver. Uniaxial tensile elongation was carried out using a Shimadzu Autograph AGS-X tensile tester. Melt blends were prepared using a vertical conical counter-rotating twin screw batch compounder with a 2.5 mm diameter extrusion die and 5 g capacity mixing chamber. All polymer processing was carried out on pristine materials (i.e., no BHT, other antioxidants, or additives were added). Further experimental details are provided in the appropriate sections below.

Materials: Toluene was purified over columns of alumina and copper (Q5) and molecular sieves prior to use. Ethylene (Matheson, Matheson purity) and propylene (Airgas, polymer grade) were purified over columns of copper Q5 and 4 Å molecular sieves. Vinyl chloride was purchased from Synquest Laboratories and used as received. B(C₆F₅)₃ was obtained from TCI Chemicals and used as received. Pyridylamidohafnium catalyst (1) was prepared according known methods. rac-Dimethylsilanediylbis(2-methyl-4-phenylindenyl) zirconium dichloride (rac-MPSBI-ZrCl₂) was synthesized according to literature procedure. Methylaluminoxane (MAO) was obtained from Albemarle as a 30 wt % solution in toluene and dried at 40° C. under vacuum for at least 12 hours. (Caution: residual trimethylaluminum is removed during this step and the solvent traps should be vented carefully and quenched with iPrOH). Diisobutylaluminumphenolate (DIBAP) was prepared by adding BHT (0.220 g, 1.00 mmol, 1.00 equiv.) in toluene (2 mL) to Al(iBu)3 (0.198 g, 1.00 mmol, 1.00 equiv.) in toluene (2 mL) dropwise inside a glovebox and stored in a Teflon cap sealed vial. Isotactic polypropylene (iPP) was obtained from Dow Chemical Company (H314-02Z; Mₙ=100 kg/mol; Ð=4.1; Tₘ=163° C.; MFI=2.0 g/10 min at 230° C. with 2.16 kg). High-density polyethylene (HDPE) was obtained from Dow (DMDA8904; Mₙ=22 kg/mol; Ð=3.8; Tₘ=131° C.; MFI=4.4 g/10 min at 190° C. with 2.16 kg).

General Synthesis of iPP Macromonomers:

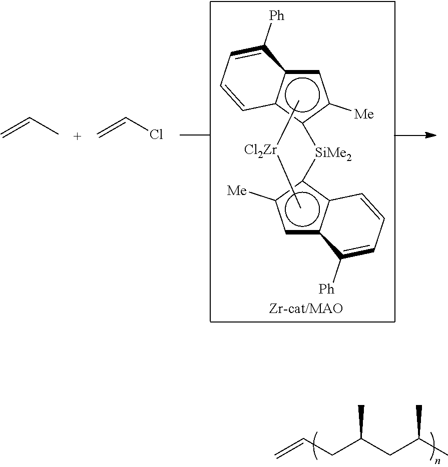

General synthesis of macromonomers was adapted from known procedures.

In a glovebox, MAO (0.116 g, 2.00 mmol) and PhMe (100 mL or 200 mL) were loaded into a 6 oz. Fischer-Porter bottle. Outside of the glove box, a set amount of vinyl chloride was condensed into a pretared flask (Caution! Vinyl chloride is very toxic. The fume hood was kept under high exhaust for the duration of the experiment). The Fisher-Porter bottle was pressurized with 15 psig propylene for 15 min. A solution of rac-MPSBI-ZrCl₂ (Zr-cat) (1.40 mg, 2.00 μmol) in PhMe (2.5 mL) was added to the flask. The reaction was stirred under a continuous feed of propylene at room temperature for a set amount of time. The reaction was quenched by adding MeOH (5 mL) and the reaction mixture was poured into MeOH (200 mL) and stirred for 3 h. The precipitated polymer was dried at 40° C. for 4 h, then re-dissolved in boiling PhMe and filtered through Celite. After cooling to room temperature, the precipitate was collected by filtration and dried in vacuum at 40° C. until it reached a constant weight. The macromonomer was then dried under high vacuum at 80° C. for 14 h before transferring to the glove box for graft copolymer synthesis (See Table 2 for details).

Allyl termination of polymer was verified by ¹H-NMR for selected samples.

TABLE 2
Characterization and properties of macromonomers.

| | PhMe | [CTA]/ | Time | Mₙ^{GPC} | | Mₙ^{NMR} | Yield | Mₙ^{theo} |
|---|---|---|---|---|---|---|---|---|
| Entry | (mL) | [Zr] | (min) | (kDa)^{a} | Ð^{a} | (kDa) | (g) | (kDa) |
| 1 | 100 | None | 2 | 159 | 3.0 | — | 1.86 | 880 |
| 2 | 100 | 14600 | 240 | 6 | 2.2 | — | 6.29 | 2,300 |
| 3 | 100 | 7050 | 120 | 14 | 2.1 | 16 | 4.33 | 3,200 |
| 4 | 200 | 6130 | 120 | 14 | 2.2 | — | 10.0 | 2,100 |
| 5 | 200 | 2460 | 120 | 26 | 2.3 | 24 | 16.9 | 3,700 |
| 6 | 200 | 2210 | 120 | 28 | 2.4 | 26 | 20.4 | 4,200 |

^{a}Determined by GPC using polyethylene standards at 150° C. in 1,2,4-trichlorobenzene

General Synthesis of Graft Copolymers: In a glove box, iPP macromonomer (0.50-2.00 g), DIBAP (0.1 mL), and PhMe (50 or 100 mL) were loaded into a 6 oz. Fischer-Porter bottle. The reaction vessel was then heated to 100° C. in an oil bath until all macromonomer has dissolved (approximately 30 min) and then maintained at 100° C. for an additional 15 min. The reaction vessel was then transferred to a 70° C. oil bath and pressurized with ethylene at a set pressure for 15 min. During this time, in a glovebox, pyridylamidohafnium catalyst (6.40 mg, 10.0 μmol) and cocatalyst B(C₆F₅)₃ (5.40 mg, 10.5 μmol) were combined in a 20 mL scintillation vial and dissolved in PhMe (3 mL). The solution was allowed to react for 5 min, transferred to a gas tight syringe, and added to the Fischer-Porter bottle. The reaction was stirred at 70° C. for 30 min under a continuous feed of ethylene. At the end of the reaction, the monomer feed was stopped, the Fisher-Porter bottle was vented, and the polymerization was quenched with MeOH (4 mL). The product was precipitated into MeOH (200 mL) and stirred for 2 h. The polymer was collected by filtration and dried in vacuum at 40° C. for 4 h.

¹⁸⁵PE_{5.2}-g-₁₆iPP₆ (Table 1, Entry 1) Following the above method, 6K-iPP (Table 2, Entry 2) (1.0 g), PhMe (50 mL), DIBAP (0.1 mL), [Hf] (6.4 mg), B(C₆F₅)₃ (5.4 mg), and ethylene (10 psig) were combined at 70° C. for 30 min. 1.33 g of a polymer mixture with 40% macromonomer incorporation and 16 grafts per chain was obtained (see Table 3 for details).

²²¹PE₁₅-g-₁₀iPP₆ (Table 1, Entry 2) Following the above method, 6K-iPP (Table 2, Entry 2) (1.0 g), PhMe (50 mL), DIBAP (0.1 mL), [Hf] (6.4 mg), B(C₆F₅)₃ (5.4 mg), and ethylene (20 psig) were combined at 70° C. for 30 min. 1.88 g of a polymer mixture with 40% macromonomer incorporation and 10 grafts per chain was obtained (see Table 3 for details).

63PE5.5-g-5.0iPP6 (Table 1, Entry 3) Following the above method, 6K-iPP (Table S1, Entry 2) (1.0 g), PhMe (50 mL), DIBAP (0.1 mL), [Hf] (6.4 mg), B(C6F5)3 (5.4 mg), and ethylene (10 psig) were combined at 70° C. for 15 min. 1.20 g of a polymer mixture with 21% macromonomer incorporation and 5 grafts per chain was obtained (see Table S2 for details).

¹⁶⁴PE₁₃-g-_{5.5}iPP₁₄ (Table 1, Entry 4) Following the above method, 14K-iPP (Table 2, Entry 3) (0.5 g), PhMe (50 mL), DIBAP (0.1 mL), [Hf] (6.4 mg), B(C₆F₅)₃ (5.4 mg), and ethylene (10 psig) were combined at 70° C. for 30 min. 0.73 g of a polymer mixture with 40% macromonomer incorporation and 5.5 grafts per chain was obtained (see Table 3 for details).

²¹⁰PE_{8.9}-g-_{8.8}iPP₁₄ (Table 1, Entry 5) Following the above method, 14K-iPP (Table 2, Entry 3) (0.75 g), PhMe (50 mL), DIBAP (0.1 mL), [Hf] (6.4 mg), B(C₆F₅)₃ (5.4 mg), and ethylene (10 psig) were combined at 70° C. for 30 min. 1.04 g of a polymer mixture with 53% macromonomer incorporation and 8.8 grafts per chain was obtained (see Table 3 for details).

²⁶⁰PE_{8.8}-g-₁₁iPP₁₄ (Table 1, Entry 6) Following the above method, 14K-iPP (Table 2, Entry 4) (1.0 g), PhMe (50 mL), DIBAP (0.1 mL), [Hf] (6.4 mg), B(C₆F₅)₃ (5.4 mg), and ethylene (10 psig) were combined at 70° C. for 30 min. 1.46 g of a polymer mixture with 60% macromonomer incorporation and 11 grafts per chain was obtained (see Table 3 for details).

²¹³PE₅₇-g-_{2.2}iPP₁₄ (Table 1, Entry 7) Following the above method, 14K-iPP (Table 2, Entry 4) (1.0 g), PhMe (50 mL), DIBAP (0.1 mL), [Hf] (6.4 mg), B(C₆F₅)₃ (5.4 mg), and ethylene (20 psig) were combined at 70° C. for 30 min. 1.73 g of a polymer mixture with 12% macromonomer incorporation and 2.2 grafts per chain was obtained (see Table 3 for details).

³⁶⁴PE₇₄-g-_{2.9}iPP₂₆ (Table 1, Entry 8) Following the above method, 26K-iPP (Table 2, Entry 5) (1.0 g), PhMe (100 mL), DIBAP (0.1 mL), [Hf] (6.4 mg), B(C₆F₅)₃ (5.4 mg), and ethylene (10 psig) were combined at 70° C. for 30 min. 1.99 g of a polymer mixture with 26% macromonomer incorporation and 2.9 grafts per chain was obtained (see Table 3 for details).

²⁹⁸PE₃₀-g-_{4.6}iPP₂₈ (Table 1, Entry 9) Following the above method, 28K-iPP (Table 2, Entry 6) (1.5 g), PhMe (100 mL), DIBAP (0.1 mL), [Hf] (6.4 mg), B(C₆F₅)₃ (5.4 mg), and ethylene (10 psig) were combined at 70° C. for 30 min. 2.05 g of a polymer mixture with 29% macromonomer incorporation and 4.6 grafts per chain was obtained (see Table 3 for details).

³⁹⁸PE₁₅-g-_{9.3}iPP₂₆ (Table 1, Entry 10) Following the above method, 26K-iPP (Table 2, Entry 5) (2.0 g), PhMe (100 mL), DIBAP (0.1 mL), [Hf] (6.4 mg), B(C₆F₅)₃ (5.4 mg), and ethylene (10 psig) were combined at 70° C. for 30 min. 2.52 g of polymer mixture with 40% macromonomer incorporation and 9.3 grafts per chain was obtained (see Table 3 for details).

⁴¹³PE₃₉-g-_{5.6}iPP₂₈ (Table 1, Entry 11) Following the above method, 28K-iPP (Table 2, Entry 6) (2.0 g), PhMe (100 mL), DIBAP (0.1 mL), [Hf] (6.4 mg), B(C₆F₅)₃ (5.4 mg), and ethylene (20 psig) were combined at 70° C. for 30 min. 3.08 g of a polymer mixture with 33% macromonomer incorporation and 5.6 grafts per chain (see Table 3 for details).

³²⁰PE_{9.8}-g-_{8.2}iPP₂₈ (Table 1, Entry 12) Following the above method, 28K-iPP (Table 2, Entry 6) (2.0 g), PhMe (100 mL), DIBAP (0.1 mL), [Hf] (6.4 mg), B(C₆F₅)₃ (5.4 mg), and ethylene (10 psig) were combined at 70° C. for 15 min. 2.36 g of a polymer mixture with 46% macromonomer incorporation and 8.2 grafts per chain was obtained (see Table 3 for details).

TABLE 3
Calculation of graft copolymer composition.

| | Area | Mass | | | | | | Mₚ of |
|---|---|---|---|---|---|---|---|---|
| | fit | of | GPC | wt % | wt % | | | graft |
| | (mV | MM | sample | MM in | MM in | | Graft/ | polymer |
| Entry | min)^{a} | (mg)^{b} | (mg) | sample^{c} | exp^{d} | % incorp^{e} | chair/ | (kDa)^{g} |
| ¹⁸⁵PE_{5.2}-g-₁₆iPP₆ | 16.05 | 1.04 | 2.30 | 45.3 | 75.2 | 39.8 | 17.9 | 209 |
| | 15.32 | 0.99 | 2.20 | 45.2 | 75.2 | 39.9 | 13.7 | 160 |
| Average | | | | | | 39.9 | 15.8 | 185 |
| ²²¹PE₁₅-g-₁₀iPP₆ | 6.65 | 0.43 | 1.60 | 26.9 | 53.2 | 49.3 | 10.8 | 193 |
| | 14.72 | 0.96 | 2.60 | 36.8 | 53.2 | 30.9 | 10.1 | 248 |
| Average | | | | | | 40.1 | 10.4 | 221 |
| ⁶³PE_{5.5}-g-_{5.0}iPP₆ | 17.10 | 1.11 | 1.80 | 61.7 | 83.3 | 26.0 | 5.6 | 63 |
| | 25.90 | 1.68 | 2.40 | 70.1 | 83.3 | 15.9 | 4.3 | 62 |
| Average | | | | | | 21.0 | 5.0 | 63 |
| ¹⁶⁴PE₁₃-g-_{5.5}iPP₁₄ | 19.66 | 1.12 | 2.60 | 43.2 | 68.2 | 36.7 | 5.2 | 163 |
| | 15.01 | 0.86 | 2.20 | 38.9 | 68.2 | 42.9 | 5.7 | 164 |
| Average | | | | | | 39.8 | 5.5 | 164 |
| ²¹⁰PE_{8.9}-g-_{8.8}iPP₁₄ | 9.13 | 0.52 | 1.70 | 30.7 | 72.1 | 57.5 | 9.2 | 213 |
| | 14.08 | 0.80 | 2.20 | 36.5 | 72.1 | 49.3 | 8.4 | 207 |
| Average | | | | | | 53.4 | 8.8 | 210 |
| ²⁶⁰PE_{8.8}-g-₁₁iPP₁₄ | 7.68 | 0.65 | 2.50 | 25.9 | 68.4 | 62.0 | 9.6 | 230 |
| | 7.86 | 0.66 | 2.30 | 28.9 | 68.4 | 57.7 | 11.7 | 289 |
| Average | | | | | | 59.9 | 10.7 | 260 |
| ²¹³PE₅₇-g-_{2.2}iPP₁₄ | 11.83 | 1.00 | 1.90 | 52.6 | 57.9 | 9.3 | 1.8 | 214 |
| | 13.94 | 1.18 | 2.40 | 49.1 | 57.9 | 15.3 | 2.7 | 211 |
| Average | | | | | | 12.3 | 2.2 | 212 |
| ³⁶⁴PE₇₄-g-_{2.9}iPP₂₆ | 11.14 | 0.86 | 2.20 | 39.3 | 50.3 | 21.8 | 2.2 | 322 |
| | 9.06 | 0.70 | 2.00 | 35.2 | 50.3 | 30.1 | 3.6 | 406 |
| Average | | | | | | 25.9 | 2.9 | 364 |
| ²⁹⁸PE₃₀-g-_{4.6}iPP₂₈ | 19.43 | 1.22 | 2.20 | 55.4 | 73.0 | 24.1 | 4.5 | 316 |
| | 19.08 | 1.20 | 2.50 | 47.9 | 73.0 | 34.4 | 4.8 | 279 |
| Average | | | | | | 29.3 | 4.6 | 298 |
| ³⁹⁸PE₁₅-g-_{9.3}iPP₂₆ | 15.13 | 1.17 | 2.40 | 48.9 | 79.5 | 38.4 | 9.3 | 405 |
| | 16.17 | 1.26 | 2.70 | 46.5 | 79.5 | 41.5 | 9.3 | 391 |
| Average | | | | | | 40.0 | 9.3 | 398 |
| ⁴¹³PE₃₉-g-_{5.6}iPP₂₈ | 15.90 | 1.00 | 2.20 | 45.4 | 65.0 | 30.2 | 5.2 | 408 |
| | 14.82 | 0.93 | 2.20 | 42.3 | 65.0 | 35.0 | 5.9 | 419 |
| Average | | | | | | 32.6 | 5.6 | 413 |
| ³²⁰PE_{9.8}-g-_{8.2}iPP₂₈ | 18.27 | 1.15 | 2.40 | 47.8 | 84.9 | 43.7 | 8.1 | 321 |
| | 16.68 | 1.05 | 2.40 | 43.6 | 84.9 | 48.6 | 8.3 | 319 |
| Average | | | | | | 46.2 | 8.2 | 320 |

Graft copolymer nomenclature: ^{w}PEₓ-g-_{y}iPP_{z}, where w = Mₚ of the polymer, x = Mₙ of the average PE spacers calculated as x = (Mₚ − number of grafts × Mₙ of MM)/(number of grafts + 1), y = average iPP grafts per chain, z = Mₙ of iPP macromonomer.
^{a}Determined from curve fitting.
^{b}Determined from area vs GPC sample mass plot for macromonomer used.
^{c}Calculated as mass of MM (mg)/GPC sample (mg) \acute{ } 100.
^{d}Calculated as mass of MM used in experiment (g)/yield of polymer mixture (g) × 100.
^{e}Calculated as (100-wt % MM in sample)/wt % MM in experiment × 100.
^{f}Calculated as a moles of macromonomer incorporated divided by the moles of graft copolymer.
^{g}Determined from polynomial equation of experimental GPC calibration curve used for this study using peak retention time of graft copolymer obtained from curve fitting plot.

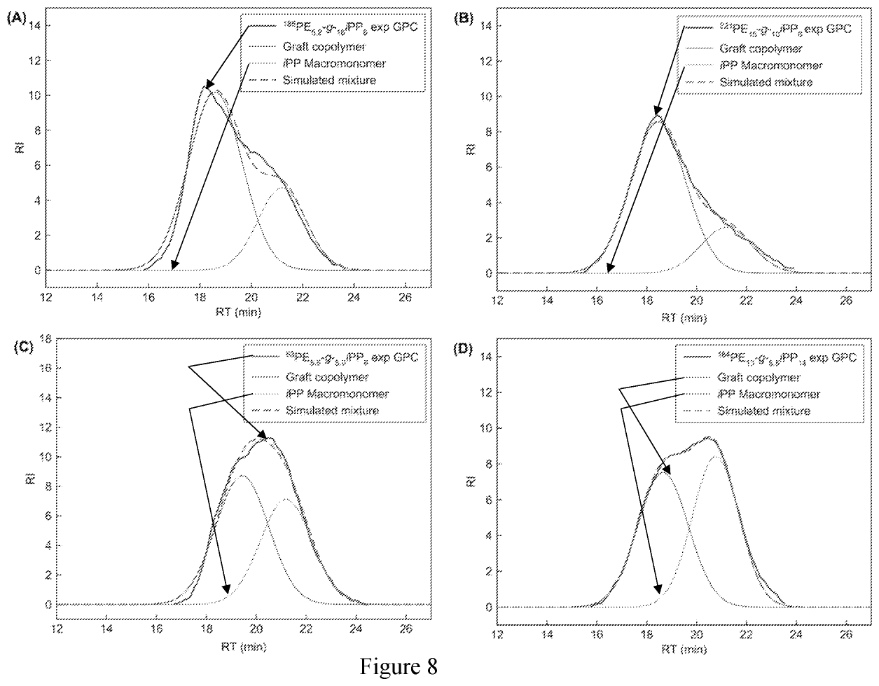

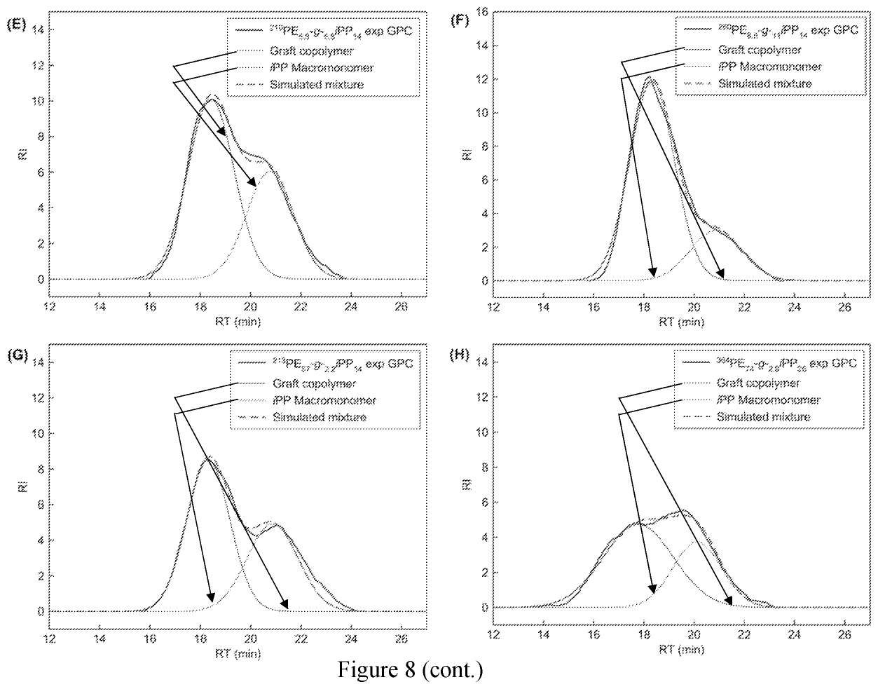

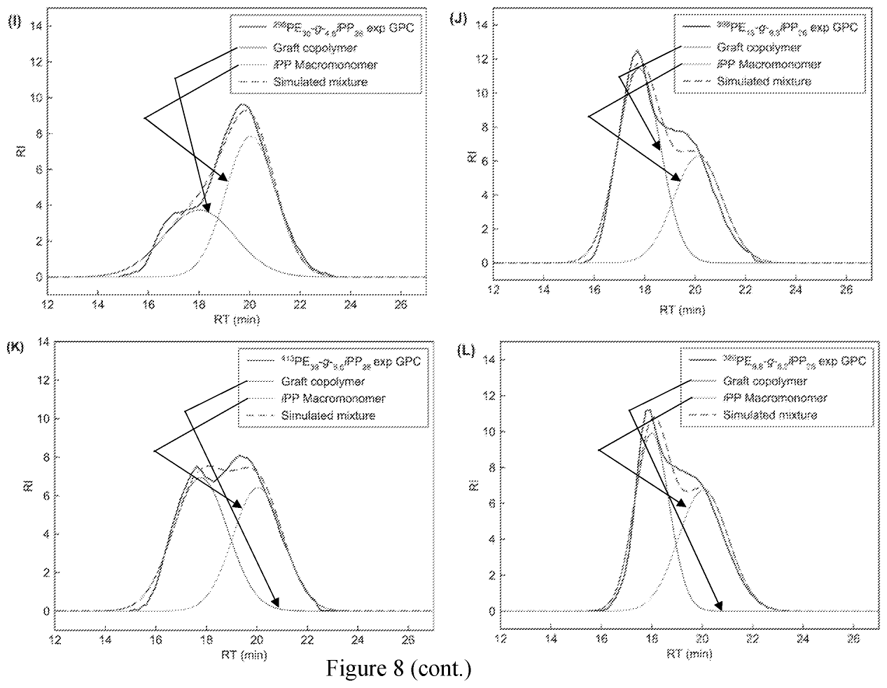

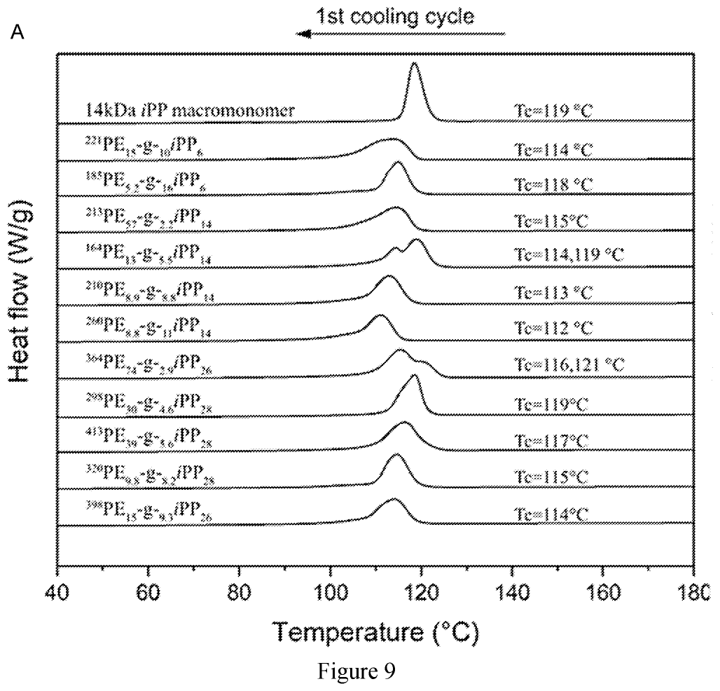

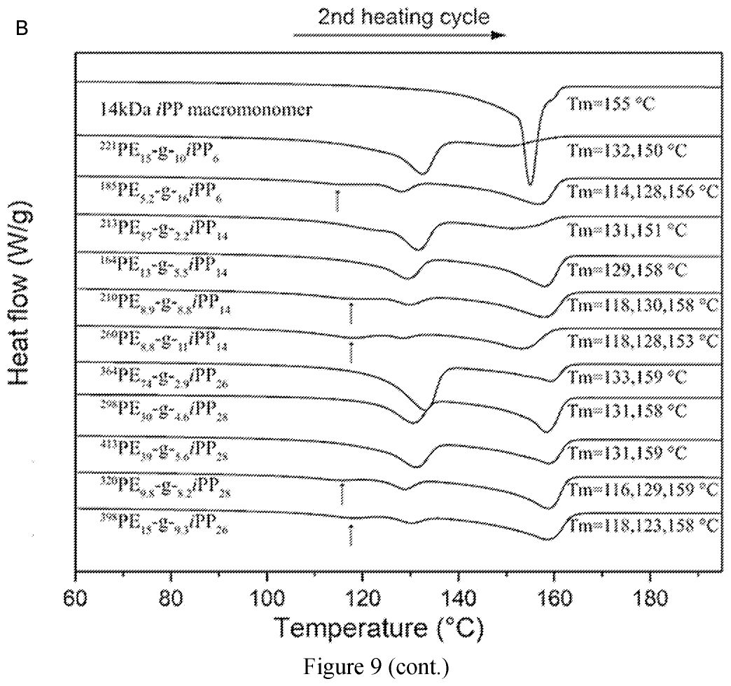

Analysis of Graft Copolymers: The graft copolymers in Table 1 contain residual unreacted macromonomer. The macromonomer incorporation as well as graft copolymer molecular weight was estimated by fitting experimental GPC curves of polymer/macromonomer mixtures to two overlapping Gaussian curves (See FIG. 8). This method assumes symmetrical peaks for both polymers in polymer mixture. Unreacted macromonomer in the polymer can then be quantified based on experimental correlation of macromonomer peak area and GPC sample mass (See FIG. 7). Gaussian fits were obtained by keeping the fitted macromonomer peak width and peak retention time constant relative to experimental macromonomer data obtained from GPC, allowing for automatic adjustment of the macromonomer peak area when performing fits.

Blend Preparation: Polymer pellets of Dow iPP (H314-02Z, 1.2 g) and Dow HDPE (DMDA8904, 2.8 g) and a set amount of graft copolymer powder (normalized based on weight fraction in graft copolymer/macromonomer mixture) were combined and pressed at 180° C. for 5 minutes with minimal pressure to create a coherent film. The film was fed into a twin screw microcompounder at 190° C. with a steady flow of argon and residence time of 8 minutes at 130 rpm. The material was then extruded through a 2.5 mm diameter die and air cooled. The resulting blend was then pressed at 180° C. for 5 minutes with minimal pressure to create a coherent film.

Dogbone Tensile Bar Preparation: Blend films were loaded into a stainless-steel dogbone die (gauge length=10 mm, gauge width=2.6 mm, gauge thickness=0.6 mm) and pressed on a Carver press hot plate under ˜52 MPa at 180° C. for 5 minutes. Maintaining this pressure, the sample was cooled using water circulation (˜10° C./min unless otherwise noted). The samples were removed and trimmed with a razor blade.

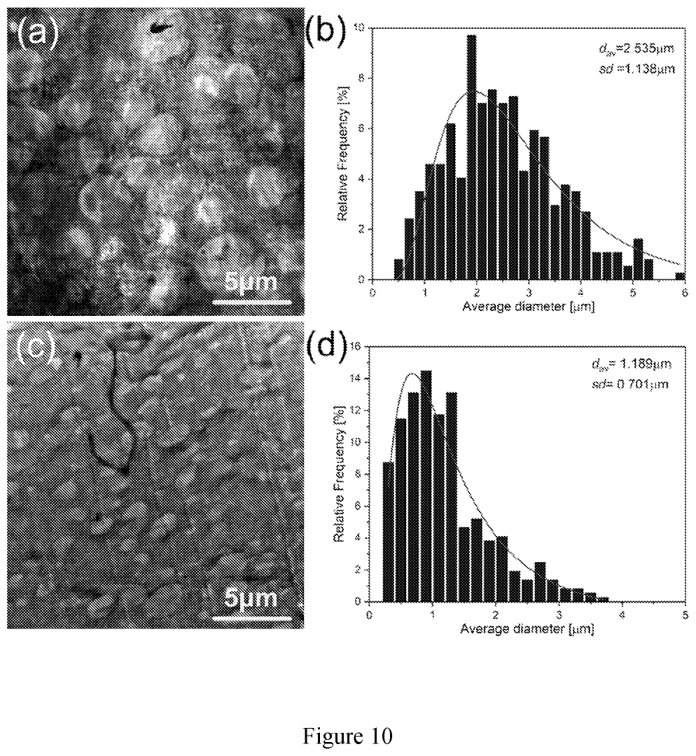

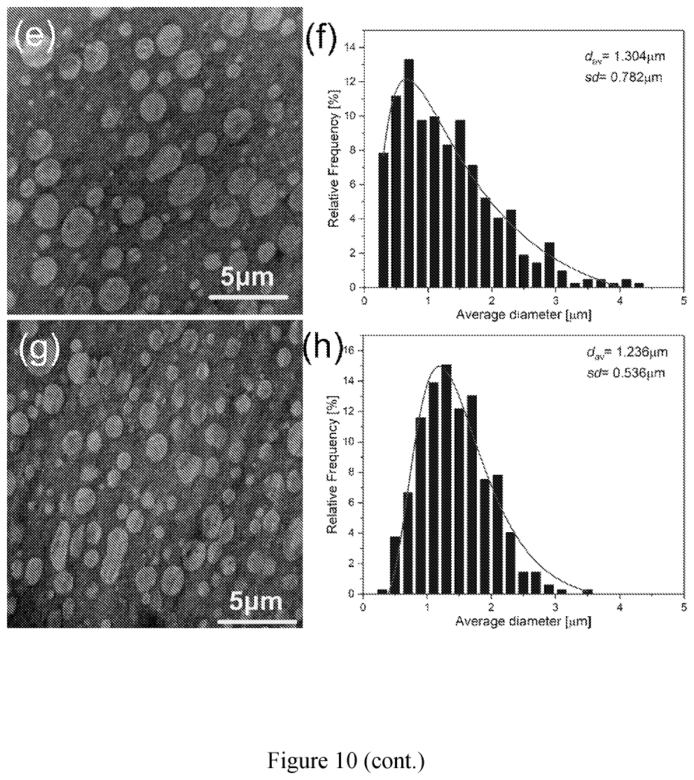

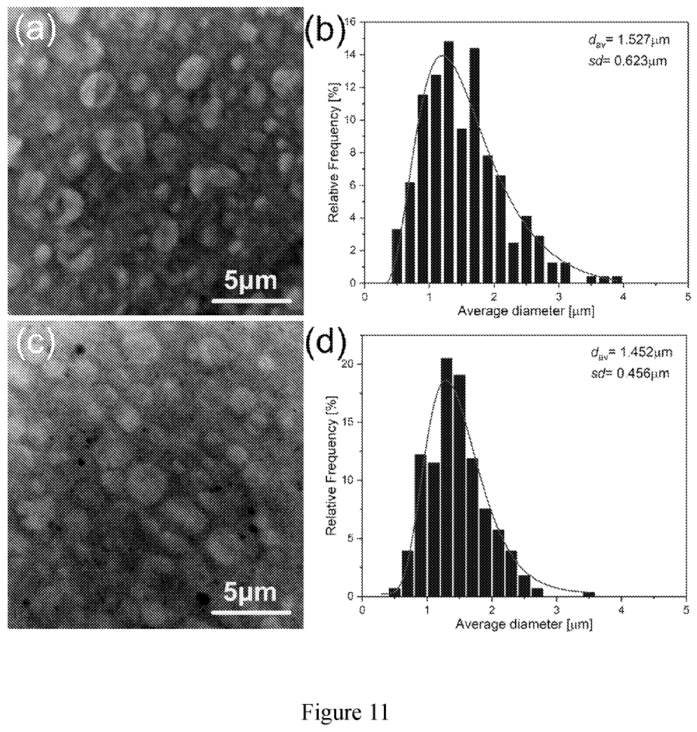

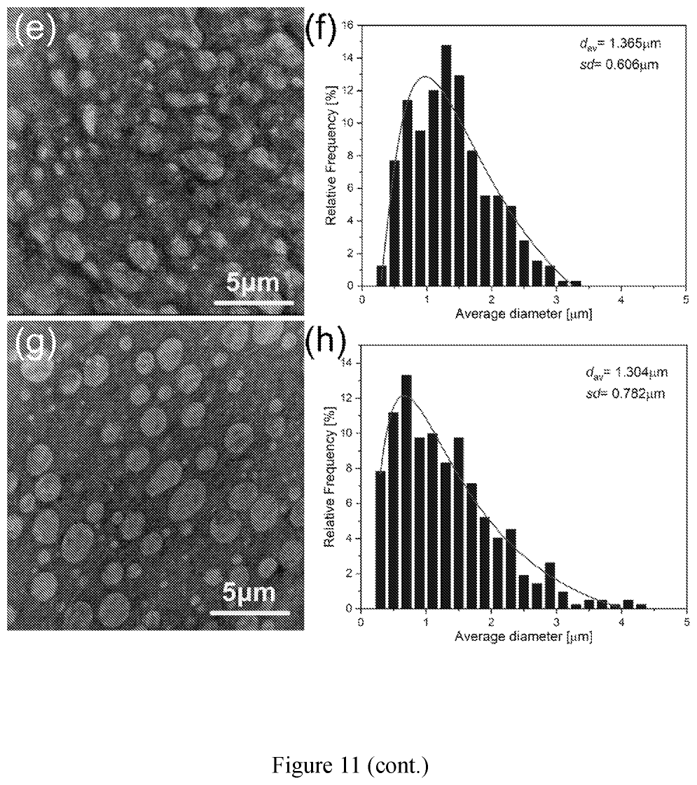

Blend Morphology Analysis: To characterize the blend morphology with transmission electron microscopy (TEM), unstretched tensile bars were cryo-sectioned at −120° C. on a Leica EM UC6 ultramicrotome with Model FC-S Cryo attachment to obtain a smooth surface. The specimens were then stuck on the vial cap with double-sided tape, ready to be stained with RuO₄ solutions in the closed vial. The RuO₄ solution was freshly prepared, typically by mixing 15 mg RuCl₃ and 2 mL sodium hypochlorite in a 15 mL vial. After staining for 2 h, the specimens were cryo-microtomed to obtain the ultrathin sections (thickness around 70 nm) with a Micro Star diamond knife. A Tecnai G2 Spirit Biotwin microscope was utilized to image the thin sections with an accelerating voltage of 120 kV. Droplet size analysis were performed on Image J for the TEM micrograph. For each sample, at least 250 droplets were analyzed and area for each droplet was obtained, where the diameter was calculated by assuming perfect circle for each droplet. Histograms of droplet size distribution was plotted and were fitted to log-normal distribution. Representative TEM micrographs and size distribution are displayed in FIGS. 10 and 11.

Atomic Force Microscopy: Atomic force microscopy (AFM) was conducted to characterize the blend morphologies for tensile test samples before and after tensile testing. Unstretched samples were used as prepared. The stretched samples were first embedded in epoxy in order to observe under AFM along the uniaxial extension direction. Both samples were microtomed at −140° C. on Leica EM UC6 ultramicrotome with Model FCS Cryo attachment. A series of consecutive cuts, initially with a glass knife at a 1 μm step length, then with a Diatome diamond knife at 100 nm step length, were conducted to obtain smooth surfaces. AFM was performed using a Bruker Nanoscope V with AC mode. The samples were examined in the repulsive regime by a silicon tip (HQ: NSC36/AL BS, NanoAndMore USA Corp.) with radius of 8 nm, resonance frequency of 130 kHz, and force constant of 2 N/m. For the unstretched samples, droplet size analysis was performed using ImageJ, and at least 100 droplets were included for the size calculation.

Mechanical Testing: Mechanical studies were performed using a Shimadzu Autograph AGS-X tensile tester elongated with a crosshead velocity of 10 using TrapeziumX v. 1.5.1 software. Representative traces are presented in FIGS. 3 and 5 and compiled individual traces are presented below in FIG. 10.

TABLE 4
Average strain break for blends.

| | | Wt % added | | |
|---|---|---|---|---|
| | | to 30/70 | Sample | |
| Entry | GCP | iPP/HDPE | plot | ε, % |
| 1 | ¹⁸⁵PE_{5.2}-g-₁₆iPP₆ | 5.0 | A | 950 ± 50 |
| 2 | ²²¹PE₁₅-g-iPP₆ | 5.0 | B | 100 ± 60 |
| 3 | ¹⁶⁴PE₁₃-g-_{5.5}iPP₁₄ | 5.0 | C | 57 ± 16 |
| 4 | ²¹⁰PE_{8.9}-g-_{8.8}iPP₁₄ | 5.0 | D | 850 ± 30 |
| 5 | ²⁶⁰PE_{8.8}-g-₁₁₇iPP₁₄ | 5.0 | E | 990 ± 80 |
| 6 | ²¹³PE₅₇-g-_{2.2}iPP₁₄ | 5.0 | F | 210 ± 20 |
| 7 | ³⁶⁴PE₇₄-g-_{2.9}iPP₂₆ | 5.0 | G | 17 ± 2 |
| 8 | ²⁹⁸PE₃₀-g-_{4.6}iPP₂₈ | 5.0 | H | 31 ± 4 |
| 9 | ³⁹⁸PE₁₅-g-_{9.3}iPP₂₆ | 5.0 | I | 910 ± 80 |
| 10 | ⁴¹³PE₃₉-g-_{5.6}iPP₂₈ | 5.0 | J | 620 ± 180 |
| 11^{a} | ⁴¹³PE₃₉-g-_{5.6}iPP₂₈ | 5.0 | J1 | 860 ± 60 |
| 12 | ³²⁰PE_{9.8}-g-_{8.2}iPP₂₈ | 5.0 | K | 910 ± 70 |
| 13 | ¹⁸⁵PE_{5.2}-g-₁₆iPP₆ | 1.0 | L | 200 ± 50 |
| 14 | ¹⁸⁵PE_{5.2}-g-₁₆iPP₆ | 5.0 | M | 150 ± 60 |
| 15^{a} | ¹⁸⁵PE_{5.2}-g-₁₆iPP₆ | 1.0 | N | 600 ± 170 |
| 16^{a} | ¹⁸⁵PE_{5.2}-g-₁₆iPP₆ | 0.5 | O | 55 ± 46 |
| 17 | ²⁶⁰PE_{8.8}-g-₁₁iPP₁₄ | 1.0 | P | 190 ± 100 |
| 18 | ²⁶⁰PE_{8.8}-g-₁₁iPP₁₄ | 0.5 | Q | 35 ± 10 |
| 19^{a} | ²⁶⁰PE_{8.8}-g-₁₁iPP₁₄ | 1.0 | R | 850 ± 80 |
| 20^{a} | ²⁶⁰PE_{8.8}-g-₁₁iPP₁₄ | 0.5 | S | 17 ± 3 |
| 21 | ³⁹⁸PE₁₅-g-_{9.3}iPP₂₆ | 1.0 | T | 410 ± 140 |
| 22 | ³⁹⁸PE₁₅-g-_{9.3}iPP₂₆ | 0.5 | U | 22 ± 1 |
| 23^{a} | ³⁹⁸PE₁₅-g-_{9.3}iPP₂₆ | 1.0 | V | 870 ± 60 |
| 24^{a} | ³⁹⁸PE₁₅-g-_{9.3}iPP₂₆ | 0.5 | X | 30 ± 12 |
| 25 | 6K PP MM | 5.0 | Y | 18 ± 2 |
| 26^{b} | iPP | — | Z | 560 ± 50 |
| 27^{b} | HDPE | — | A1 | 1170 ± 170 |
| 28^{b} | iPP/HDPE 30/70 | — | B1 | 17 ± 1 |
| 29^{a,b} | HDPE | — | C1 | 1720 ± 70 |
| 30^{a,b} | iPP | — | D1 | 860 ± 70 |
| 31^{a,b} | iPP/HDPE 30/70 | — | El | 13 ± 2 |

^{a}Cooled at 23° C./min rate.
^{b}Virgin polymers and polymer blends.

Although the present disclosure has been described with respect to one or more particular embodiments and/or examples, it will be understood that other embodiments and/or examples of the present disclosure may be made without departing from the scope of the present disclosure.

1. A graft copolymer comprising:
a semi-crystalline polyethylene (PE) segment; and
a plurality of semi-crystalline isotactic polypropylene (iPP) segments, wherein each semi-crystalline isotactic polypropylene segment is covalently bonded to the semi-crystalline polyethylene segment and the iPP segments are pendent groups.

2. The graft copolymer of claim 1, wherein the number average molecular weight (Mₙ) of the graft copolymer is 25-1000 kDa.

3. The graft copolymer of claim 1, wherein the number average molecular weight (Mₙ) of the portion of the PE segment between each iPP segment is 1-100 kDa.

4. The graft copolymer of claim 1, wherein the average number of iPP segments is 1-50.

5. The graft copolymer of claim 1, wherein the number average molecular weight (Mₙ) of the iPP segments is 1-50 kDa.

6. The graft copolymer of claim 1, wherein the graft copolymer comprises the following structure: 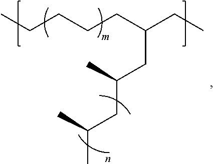
where m is 36 to 3600, and n is 24 to 1200.

7. The graft copolymer of claim 1, wherein the graft copolymer end groups are saturated or unsaturated aliphatic groups.

8. The graft copolymer of claim 1, wherein the PE segment comprises one or more polypropylene group(s) and/or one or more comonomer(s) and/or the iPP segment comprises one or more ethylene group(s) and/or one or more comonomer(s).

9. A graft copolymer blend comprising one or more graft copolymer(s) of any one of claims 1-8 and one or more semi-crystalline polyethylene(s) or one or more graft copolymer(s) of any one of claims 1-8 and one or more isotactic polypropylene(s) (iPP(s)) or one or more graft copolymers of any one of claims 1-8 and one or more semi-crystalline polyethylene(s) and one or more iPP(s).

10. The graft copolymer blend of claim 9, wherein the iPP/semi-crystalline polyethylene ratio is 1/99 to 99/1 (w/w).

11. The graft copolymer blend of claim 9, wherein the total concentration of the one or more graft copolymer(s) is 0.1 to 20 wt % relative to the total weight of the graft copolymer blend.

12. A method of making a graft copolymer comprising:
forming a reaction mixture comprising:
one or more iPP macromonomer(s) and
a solvent;
heating the reaction mixture;
adding ethylene to the reaction mixture;
adding a catalyst and, optionally, a cocatalyst to the reaction mixture; and
optionally quenching the reaction,
wherein the graft copolymer of any one of claims 1-8 is produced.

13. The method of claim 12, wherein the iPP macromonomer has the following structure: 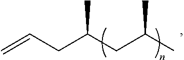
wherein n is 24 to 1200.

14. The method of claim 12, wherein the catalyst is an alkene polymerization catalyst.

15. The method of claim 14, wherein the alkene polymerization catalyst is one or more metallocene catalyst(s) and/or one or more non-metallocene catalyst(s).

16. The method of claim 14, wherein the non-metallocene catalyst is a pyridylamidohafnium catalyst.

17. The method of claim 12, wherein the cocatalyst chosen from methylalumoxane, N,N-dimethylanilinium borate salts, trityl borate salts, Lewis acids, and combinations thereof.

18. The method of claim 12, wherein polymerization of the ethylene and the iPP macromonomer is completed prior to consumption of all of the iPP macromonomer.

19. The method of claim 18, wherein 10 to 99% of the iPP macromonomer is incorporated into the graft copolymer.

20. A method of making a graft copolymer blend of any one of claims 9-11, comprising:
melt-blending the one or more graft copolymer(s) with one or more semi-crystalline polyethylene(s) or the one or more graft copolymer(s) with one or more iPP(s) or the one or more graft copolymer(s) with one or more semi-crystalline polyethylene(s) and one or more iPP(s),
wherein the graft copolymer blend is formed.

21. The method of claim 20, wherein the melt-blended graft copolymer blend is cooled at 1° C./hr to 100° C./min.

22. An article of manufacture comprising a graft copolymer blend of any one of claims 9-11.
